(19) United States
(12) Patent Application Publication
(10) Pub. No.: US 2013/0121968 A1
(43) Pub. Date: May 16, 2013

(54) Methods of combining metagenome and the metatranscriptome in multiplex profiles

(71) Applicant: Atossa Genetics, Inc., Seattle, WA (US)

(72) Inventor: Steven C. Quay, Seattle, WA (US)

(73) Assignee: Atossa Genetics, Inc., Seattle, WA (US)

(21) Appl. No.: 13/573,785

(22) Filed: Oct. 3, 2012

Related U.S. Application Data
(60) Provisional application No. 61/542,482, filed on Oct. 3, 2011.

(51) Int. Cl. G06F 19/00

(52) U.S. Cl. CPC G06F 19/34
USPC 424/93.4; 435/252.4; 435/252.3; 506/9; 435/6.12; 702/19

(57) ABSTRACT

The present invention describes changes in bacterial gastrointestinal, cutaneous and nasal microbiota associated various mammalian medical conditions. Described are diagnostic tests that arise from combining phylogenetic information about the families, genus, and species of the microbiome and their relative abundance with the metabolic information contained in the metatranscriptome to determine the presence and absence of a disease or medical condition. Provided are compositions of bacteria, co-cultures of bacteria and a carrier for use in treating the disclosed medical conditions. The described compositions restore or correct disease- or medical condition-related imbalances in the microbiome profile with culture-conditioned formulations in which the transcriptome activity of the administered organisms is optimized. Alternatively, formulations of metabolites that drive changes in the metatranscriptome native to the mammal that treat disease or a medical condition or restore health are taught.

### CROSS-REFERENCE

This application claims the benefit of U.S. Provisional Application No. 61/542,482, filed Oct. 3, 2011, which application is incorporated herein by reference in its entirety.

### BACKGROUND OF THE INVENTION

The average human body, consisting of about 10¹³ cells, has about ten times that number of microorganisms. The ˜10¹⁴ microbes that live in, and on, each of our bodies belong to all three domains of life on earth: bacteria, archaea and eukarya. The major sites for indigenous microbiota are the gastrointestinal tract, skin and mucosal surfaces such as nasal mucosa and vagina as well as the oropharynx, with the largest bacterial populations residing in the colon. Bacteria make up most of the flora in the colon and 60% of the dry mass of feces. There are likely more than 1000 different species live in the gut, however, >90% of the bacteria may come from less than 50 species. Fungi and protozoa also make up a part of the gut flora. The skin also has a diverse microbiome, also with likely >1000 species, yet with major populations within a small number of species (Gao et al., Proc. Natl. Acad. Sci. USA 2007, 104(8):2927-2932).

The relationship between gut flora and humans is not only commensal (a non-harmful coexistence), but is often a mutualistic, symbiotic relationship. Although animals can survive with no gut flora, the microorganisms perform a host of useful functions, such as training the immune system, preventing growth of harmful species, regulating the development of the gut, fermenting unused energy substrates, metabolism of glycans and amino acids, synthesis of vitamins (such as biotin and vitamin K) and isoprenoids, biotransformation of xenobiotics, and producing hormones to direct the host to store fats. See, e.g., Gill et al., Science. 2006, 312:1355-1359; Zaneveld et al., Curr. Opin. Chem. Biol., 2008, 12(1):109-114; Guarner, Digestion, 2006, 73:5-12; Li et al., Proc. Natl. Acad. Sci. USA, 2008, 105:2117-2122; Hooper, Trends Microbiol., 2004, 12:129-134; Mazmanian et al., Cell, 2005, 122:107-118; Rakoff-Nahoum et al., Cell, 2004, 118:229-241.

Substantial numbers of species in vertebrate microbiota are difficult to culture and analyze via traditional cultivation-based studies (Turnbaugh et al., Nature, 2007, 449:804-810; Eckburg et al., Science, 2005, 308:1635-1638).

Much of the microbiota is conserved from human to human, at least at the level of phylum and genus (for a general description of human microbiota see, e.g., Turnbaugh et al., Nature 2007; 449:804-810; Ley et al., Nature 2006; 444:1022-1023; Gao et al., Proc Natl Acad Sci USA 2007; 104:2927-32; Pei et al., Proc Natl Acad Sci USA 2004; 101:4250-4255; Eckburg et al., Science 2005; 308:1635-1638; Bik et al., Proc Natl Acad Sci USA 2006; 103:732-737). A major source of the human microbiota is from one's mother (for a summary of typical maternal colonization patterns see, e.g., Palmer et al., Plos Biology 2007; 5:e177; Raymond et al., Emerg Infect Dis 2004; 10:1816-21), and to a lesser extent from one's father and siblings (for examples of typical colonization patterns see, e.g., Raymond et al., Emerg Infect Dis 2004; 10:1816-21; Raymond et al., Plos One 2008; 3:e2259; Goodman et al., Am J Epidemiol 1996; 144:290-299; Goodman et al., Lancet 2000; 355:358-362). However, many of the natural mechanisms for the transmission of these indigenous organisms across generations and between family members have diminished with socioeconomic development. Impediments include: childbirth by caesarian section, reduced breast-feeding, smaller family size (fewer siblings), reduced household crowding with shared beds, utensils, indoor plumbing.

Effective antibiotics were discovered in the early-mid 20th century and came into wide use after World War II. Antibiotic use has increased dramatically with rates approximating one course of antibiotics per year in the average child in the USA (for a summary of US antibiotic courses in a year, see, e.g., McCaig et al., JAMA 2002; 287:3096-3102). Antibiotic use places selective pressure on the microbiota, in particular selecting for the long-term persistence of resistant organisms (such persistence is described in Levy, Sci Am 1998; 278:46-53). Antibiotic resistance may be intrinsic or secondary to acquired genetic elements, but marker organisms (and genes) may be used to observe the phenomenon (examples of such markers may be found in, e.g., Sjolund et al., Annals of Internal Medicine 2003; 139: 483-487; Sjolund et al., Emerging Infectious Diseases 2005:11:1389-1393).

Increased exposure to antibiotics in the first year of life has been associated with increased risk of developing asthma by seven years of age (Kozyrskyj et al., Chest. 2007; 131:1753-9). The effects are not specific to a single class of antibiotics, but involve many different agents. Additionally, the risk of asthma and related disorders has previously been inversely associated with the risk of having gastric colonization by H. pylori, as ascertained from serological tests (see, e.g., Reibman et al., Presented at ATS 2005; Chen and Blaser, Arch Intern Med 2007; 167:821-827; Chen and Blaser, J. Infect. Dis. 2008; 198:553-60; Blaser et al., Gut 2008; 57:561-7). The risk appears primarily limited to childhood onset asthma and related conditions.

The acute effects of antibiotic treatment on the native gut microbiota range from self-limiting “functional” diarrhea to life-threatening pseudomembranous colitis (Beaugerie and Petit, Best Pract Res Clin Gastroenterol. 2004; 18:337-352; Wilcox, Best Pract Res Clin Gastroenterol. 2003; 17:475-493). The long-term consequences of such perturbations for the human-microbial symbiosis are more difficult to discern, but chronic conditions such as asthma and atopic disease have been associated with childhood antibiotic use and an altered intestinal microbiota (see, e.g., Marra et al.; Chest. 2006; 129:610-618; Noverr and Huffnagle, Clin Exp Allergy. 2005; 35:1511-1520; Prioult and Nagler-Anderson; Immunol Rev. 2005; 206:204-218).

It has been known for more than 50 years that the administration of low doses of antibiotics promotes the growth of farm animals. As a result, the largest use of antibiotics and other antimicrobial substances is on the farm, where they are fed in low doses to large numbers of animals used for food production. Additionally, the following observations regarding antibiotic have been made: feeding low (sub-therapeutic) doses of antimicrobials promotes weight gain (often 5-10% of total weight) of animals used for food production (See, e.g., Jukes, Bioscience 1972; 22: 526-534; Jukes (1955) Antibiotics in Nutrition. New York, N.Y., USA: Medical Encyclopedia; Feighner and Dashkevicz, Appl. Environ. Microbiol., 1987, 53: 331-336; McEwen and Fedorka-Cray, Clin. Infect. Dis., 2002, 34 (Suppl 3): S93-S106); the effects are broad across vertebrates, involving at least mammals (cattle, swine, sheep), and birds (chickens and turkeys); the effects can be realized by oral administrations of the agents, suggesting that the microbiota of the gastrointestinal tract is a major target; the effects are due to many different classes of antimicrobial agents (including macrolides, tetracyclines, penicillins); anti-fungal agents do not produce the effect; the effects can be observed at many different stages in the growth and development of young animals.

The vertebrate gastrointestinal tract has a rich component of cells involved in immune responses. The nature of the microbiota colonizing experimental animals or humans affects the immune responses of the populations of reactive host cells (see, e.g., Ando et al., Infection and Immunity 1998; 66:4742-4747; Goll et al., Helicobacter. 2007; 12:185-92; Lundgren et al., Infect Immun. 2005; 73:523-531).

The vertebrate gastrointestinal tract also is a locus in which hormones are produced. In mammals, many of these hormones related to energy homeostasis (including insulin, glucagon, leptin, and ghrelin) are produced by organs of the gastrointestinal tract (see, e.g., Mix et al., Gut 2000; 47:481-6; Kojima et al., Nature 1999; 402:656-60; Shak et al., Obesity Surgery 2008; 18(9):1089-96; Roper et al., Journal of Clinical Endocrinology & Metabolism 2008; 93:2350-7; Francois et al., Gut 2008; 57:16-24; Cummings and Overduin, J Clin Invest 2007; 117:13-23; Bado et al., Nature 1998; 394:790-793). Changing of the microbiota of the gastrointestinal tract appears to affect the levels of some of these hormones (see, e.g., Breidert et al., Scand J Gastroenterol 1999; 34:954-61; Liew et al., Obes. Surg. 2006; 16:612-9; Nwokolo et al., Gut. 2003; 52, 637-640; Kinkhabwala et al., Gastroenterology 132:A208). The hormones may affect immune responses (see, e.g., Matarese et al., J Immunol 2005; 174:3137-3142; Matsuda et al., J. Allergy Clin. Immunol. 2007; 119, S174) and adiposity (see, e.g., Tschop et al., Nature 2000; 407:908-13).

### SUMMARY OF THE INVENTION

Provided herein is a method of diagnosing the presence or absence of a medical condition in a mammal comprising: comparing, using at least a general purpose computer, a multiplex profile of a metatranscriptome profile and a metogenomic profile, from a sample from the mammal, to a multiplex profile of a population of patients diagnosed with said medical condition to determine the presence or absence of the medical condition. In one embodiment, the method further comprises isolating and quantifying at least a portion of 16S ribosomal RNA of the sample to determine the metagenomic profile of the sample. In another embodiment, the method further comprises isolating and quantifying at least a portion of messenger RNA of said sample to determine the metatranscriptome profile. In yet another embodiment, the method further comprises combining the metagenomic and metatranscriptome profiles into the multiplex profile using a general purpose computer.

Provided herein is a method of treating a patient diagnosed with a medical condition as described above, comprising identifying an imbalance of microbes in a sample from said patient; and restoring or correcting disease- or medical condition-related imbalances in the microbiome based on the microbiome profile with culture-conditioned formulations in which the transcriptome activity of the administered organisms is optimized.

Provided herein is a method of diagnosing the presence or absence of a medical condition in a mammal comprising: comparing, using at least a general purpose computer, a metatranscriptome profile from a sample from the mammal to the metatranscriptome of a population of patients diagnosed with said medical condition to determine the presence or absence of the medical condition. In one embodiment, the method further comprises isolating and quantifying at least a portion of messenger RNA of said sample to determine the metatranscriptome profile.

Provided herein is a method of treating a patient diagnosed with a medical condition as described above, comprising identifying an imbalance of microbes in a sample from said patient; and restoring or correcting disease- or medical condition-related imbalances in the microbiome profile with culture-conditioned formulations in which the transcriptome activity of the administered organisms is optimized.

A mammal to be diagnosed with a method described herein includes, for example, a human, a veterinary animal, a companion pet, a domestic animal species, or a wild animal.

A medical condition to be diagnosed and/or treated with the disclosed methods can be, for example, a cancer, an infection, an inflammatory disease, an autoimmune disease, a hormonal disease, a psychological disease or a metabolic disease.

In one aspect, a psychological disease to be diagnosed with a method described herein includes those conditions that are microbiome related, for example, attention deficit hyperactive disorder (ADHD), depression, bipolar disorder and autistic spectrum disorders.

In another aspect, a cancer to be diagnosed and/or treated with the disclosed methods can be, for example, a leukemia, a lymphoma, a sarcoma or a carcinoma. Non-limiting examples of cancers include skin cancer, oral cancer, gastric cancer, pancreatic cancer, stomach cancer, colon cancer, gastrointestinal cancer, esophageal cancer, prostate cancer, testicular cancer, breast cancer and ovarian cancer.

In another aspect, an infection to be diagnosed and/or treated with the disclosed methods can be, for example, a bacterial or a viral infection. Non-limiting bacterial infections include Methicillin resistant Staphylococcus aureus (MSRA), Clostridium difficile, Pseudomonas aeruginosa or vancomycin-resistant enterococci. Non-limiting viral infections include, for example, human immunodeficiency virus (HIV).

In another aspect, an autoimmune disease to be diagnosed and/or treated with the disclosed methods can be, for example, multiple sclerosis, Ankylosing Spondylitis, Bickerstaffs encephalitis, autoimmune pancreatitis, eczema, Celiac disease, Grave's disease, Lupus erythematosus, Myasthenia gravis, Scleroderma, Sjogren's syndrome arthritis, or Rheumatoid arthritis.

In another aspect, an inflammatory disease to be diagnosed and/or treated with the disclosed methods can be, for example, irritable bowel syndrome, ulcerative colitis or Crohn's disease.

In another aspect, a metabolic disease to be diagnosed and/or treated with the disclosed methods can be, for example, a disorder of carbohydrate metabolism, amino acid metabolism, organic acid metabolism, fatty acid oxidation and mitochondrial metabolism, porphyrin metabolism, purine or pyrimidine metabolism, steroid metabolism, mitochondrial function, peroxisomal function or lysosomal storage.

Samples may be obtained by any conventional means. Samples include, but are not limited to, skin swab, skin biopsy, saliva, tooth swab, tooth scrapping, cheek swabs, throat swab, sputum, endogastric sample, feces, urine, vaginal, cervical, endocervical, endometrial, nasal swab, organ biopsy, and tissue biopsy.

Quantifying 16S ribosomal RNA may be conducted using any conventional means including commercially available kits. Methods include, but are not limited to, quantitative polymerase chain reaction (PCR), branched DNA, microarray analysis, and next generation cDNA sequencing.

Quantifying messenger RNA may be conducted using any conventional means including commercially available kits. Methods include, but are not limited to a microarray/high-density array assay or an mRNA-derived cDNA clone library assay.

Provided herein is a bacterial culture comprising a therapeutic bacteria grown in the presence of one or more other bacteria found at a desired treatment site as identified in Table 1.

The bacterial culture may further comprise one or more activators, one or more repressors, or a combination thereof.

In one embodiment, the bacterial culture produces one or more therapeutic metabolites.

One or more of the bacteria present in the bacterial culture may be genetically engineered to express or overexpress a therapeutic gene.

In one embodiment, the desired treatment site is the nasal mucosal environment and the culture comprises S. epidermidis, S. aureus, Corynebacteria, Mycobacteria, or a combination thereof.

In another embodiment, the desired treatment site is the skin and the culture comprises S. epidermidis, Corynebacteria, Mycobacteria or a combination thereof.

In yet another embodiment, the treatment site is the lower gastrointestinal tract and the culture comprises S. epidermidis, S. aureus, S. mitis, Lactobacillus sp., Clostridium sp., C. tetani, Corynebacteria, Mycobacteria.

Provided herein is a computer-implemented system for diagnosing the presence or absence of a medical condition in a mammal, comprising: (a) a digital processing device comprising an operating system configured to perform executable instructions and a memory device; and (b) a computer program including instructions executable by the digital processing device, the computer program comprising: (i) a module configured to determine a metagenomic profile by receiving and quantifying metagenomic information for at least a portion of 16S ribosomal RNA of a sample from said mammal; (ii) a module configured to determine a metatranscriptome profile by receiving and quantifying metatranscriptome information for at least a portion of messenger RNA of said sample; (iii) a module configured to compare a multiplex profile of a metatranscriptome profile and a metagenomic profile to a multiplex profile of a population of mammals diagnosed with said medical condition to determine the presence or absence of the medical condition; and (iv) a module configured to generate a report of the result of the comparison, the report comprising a diagnosis. In one embodiment, the computer program further comprises a module configured to combine the metagenomic and metatranscriptome profiles into the multiplex profile. The medical condition may be a cancer, an infection, an inflammatory disease, an autoimmune disease, a hormonal disease, a psychological disease or a metabolic disease. Quantifying the 16S ribosomal RNA may be accomplished using any method known in the art including, but not limited to, quantitative polymerase chain reaction (PCR), microarray analysis, and next generation cDNA sequencing. Quantifying the messenger RNA may be accomplished using any method known in the art including, but not limited to, a microarray/high-density array assay or an mRNA-derived cDNA clone library assay. The computer-implemented system may further comprise a database of multiplex profiles of mammals diagnosed with said medical condition.

Provided herein is a computer -implemented system for diagnosing the presence or absence of a medical condition in a mammal comprising: (a) a digital processing device comprising an operating system configured to perform executable instructions and a memory device; and (b) a computer program including instructions executable by the digital processing device, the computer program comprising: (i) a module configured to determine a metatranscriptome profile by receiving and quantifying metatranscriptome information for at least a portion of messenger RNA of a sample from said mammal; (ii) a module configured to compare the metatranscriptome profile to the metatranscriptome of a population of mammals diagnosed with said medical condition to determine the presence or absence of the medical condition; and (iii) a module configured to generate a report of the result of the comparison, the report comprising a diagnosis.

Provided herein is a non-transitory computer-readable storage media encoded with a computer program including instructions executable by a processor to create a diagnostic application comprising: (a) a module configured to determine a metagenomic profile by receiving and quantifying metagenomic information for at least a portion of 16S ribosomal RNA of a sample from a mammal; (b) a module configured to determine a metatranscriptome profile by receiving and quantifying metatranscriptome information for at least a portion of messenger RNA of said sample; (c) a module configured to compare a multiplex profile of a metatranscriptome profile and a metagenomic profile to a multiplex profile of a population of mammals diagnosed with a medical condition to determine the presence or absence of the medical condition; and (d) a module configured to generate a report of the result of the comparison, the report comprising a diagnosis. The application may further comprise a module configured to combine the metagenomic and metatranscriptome profiles into the multiplex profile. The medical condition may be a cancer, an infection, an inflammatory disease, an autoimmune disease, a hormonal disease, a psychological disease or a metabolic disease. Quantifying the 16S ribosomal RNA may be accomplished using any method known in the art including, but not limited to, quantitative polymerase chain reaction (PCR), microarray analysis, and next generation cDNA sequencing. Quantifying the messenger RNA may be accomplished using any method known in the art including, but not limited to, a microarray/high-density array assay or an mRNA-derived cDNA clone library assay. In one embodiment, the media further comprises a database of multiplex profiles of mammals diagnosed with said medical condition.

Provided herein is a non-transitory computer-readable storage media encoded with a computer program including instructions executable by a processor to create a diagnostic application comprising: (a) a module configured to determine a metatranscriptome profile by receiving and quantifying metatranscriptome information for at least a portion of messenger RNA of a sample from a mammal; (b) a module configured to compare the metatranscriptome profile to the metatranscriptome of a population of mammals diagnosed with a medical condition to determine the presence or absence of the medical condition; and (c) a module configured to generate a report of the result of the comparison, the report comprising a diagnosis.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 depicts the function for associating the metagenome and metatranscriptome to a medical condition.

### DETAILED DESCRIPTION OF THE INVENTION

High-throughput “metagenome” sequencing methods involve obtaining multiple parallel short sequencing reads looking for under- and over-represented genes in a total mixed sample population. Such sequencing is usually followed by determining the G+C content or tetranucleotide content (Pride et al., Genome Res., 2003, 13; 145) of the genes to characterize the specific bacterial species in the sample. However, such metagenomic data does not provide any information with respect to metabolic and functional capacity of a microbial community.

The present inventors have identified for the first time that the 16S ribosomal RNA (rRNA) profile from a patient sample can be combined with the metatranscriptome of the sample. When the profiles are combined in a multiplex profile, the multiplex profile can be compared to multiplex profiles of a population of patients known to have a medical condition and/or the multiplex profiles of a population of patients known to not have a medical condition. Such comparisons allow a practitioner to diagnose the presence or absence of a medical condition.

Unless defined otherwise, all technical and scientific terms used herein have the same meaning as is commonly understood by one of ordinary skill in the art.

The practice of the provided embodiments will employ, unless otherwise indicated, conventional techniques of molecular biology and the like, which are within the skill of the art. Such techniques are explained fully in the literature. See e.g., Molecular Cloning: A Laboratory Manual, (J. Sambrook et al., Cold Spring Harbor Laboratory, Cold Spring Harbor, N.Y., 1989); Current Protocols in Molecular Biology (F. Ausubel et al. eds., 1987 and updated); Current Protocols in Cell Biology. John Wiley and Sons, Inc.: Hoboken, N.J.; Coligan et al. eds. (2005) Current Protocols in Immunology, John Wiley and Sons, Inc.: Hoboken, N.J.; Coico et al. eds. (2005) Current Protocols in Microbiology, John Wiley and Sons, Inc.: Hoboken, N.J.; Coligan et al. eds. (2005) Current Protocols in Protein Science, John Wiley and Sons, Inc.: Hoboken, N.J.; and Enna et al. eds. (2005) Current Protocols in Pharmacology, John Wiley and Sons, Inc.: Hoboken, N.J.; Essential Molecular Biology (Brown ed., IRL Press 1991); Gene Expression Technology (Goeddel ed., Academic Press 1991); Methods for Cloning and Analysis of Eukaryotic Genes (Bothwell et al. eds., Bartlett Publ. 1990); Gene Transfer and Expression (Kriegler, Stockton Press 1990); Recombinant DNA Methodology (R. Wu et al. eds., Academic Press 1989); PCR: A Practical Approach (M. McPherson et al., IRL Press at Oxford University Press 1991); Cell Culture for Biochemists (R. Adams ed., Elsevier Science Publishers 1990); Gene Transfer Vectors for Mammalian Cells (Miller & M. Calos eds., 1987); and Mammalian Cell Biotechnology (M. Butler ed., 1991).

In the fields of molecular biology and biochemistry, biopolymers such as nucleic acids and proteins from organisms are identified and/or fractionated in order to search for useful genes, diagnose diseases or identify organisms. A hybridization reaction is frequently used as a pretreatment for such process, where a target molecule in a sample is hybridized with a nucleic acid or a protein having a known sequence. For this purpose, microarrays, or DNA chips, are used on which probes such as DNAs, RNAs or proteins with known sequences are immobilized at predetermined positions.

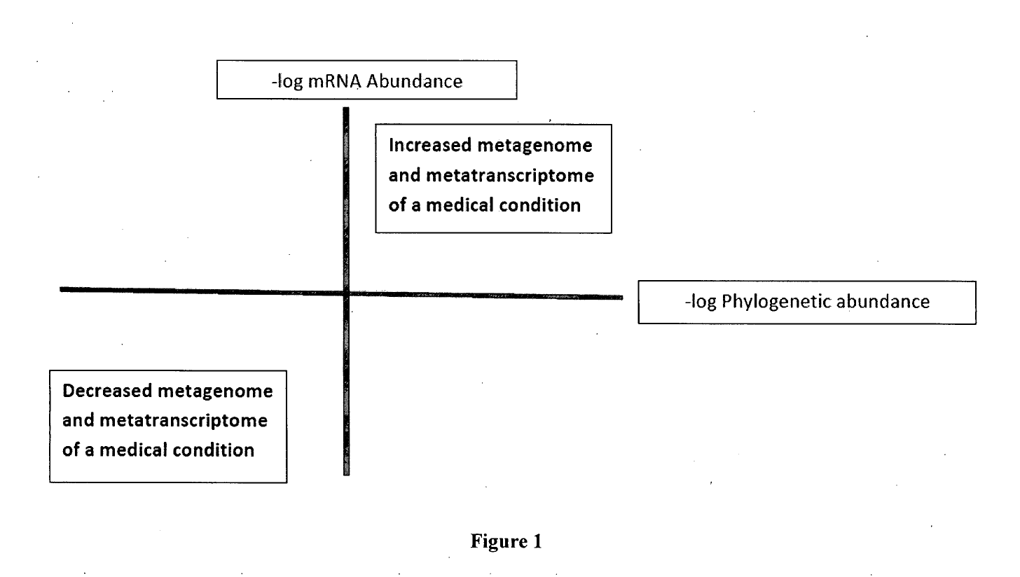

The inventors of the present application recognized the inadequacy of the metagenomics approach with respect to diagnosing and treating medical conditions because it does not provide any information as to the genes which are actively transcribed in bacteria associated with, or causing, the medical condition. Thus, the present inventors identified the applicability of metatranscriptomics in combination with the microbial 16S rRNA profile of a sample to create a multiplex profile which allows for diagnosis of a medical condition based upon the functional and metabolic activity of microbes associated with the medical condition (FIG. 1).

A “DNA microarray” (also commonly known as gene or genome chip, DNA chip, or gene array) is a collection of microscopic DNA spots attached to a solid surface, such as glass, plastic or silicon chip forming an array. The affixed DNA segments are known as probes (although some sources will use different nomenclature), thousands of which can be used in a single DNA microarray.

As used herein, “a” or “an” mean “one”, “at least one” or “one or more.”

As used herein, “nucleic acid,” “nucleic acid molecule,” “nucleic acid sequence,” “oligonucleotides,” and “polynucleotide” are used interchangeably and include both ribonucleic acid (RNA) and deoxyribonucleic acid (DNA) and modified nucleic acid molecules, such as peptide nucleic acids (PNA), locked nucleic acids (LNA), and other modified nucleic acid molecules, including, without limitation, cDNA, genomic DNA and mRNA and synthetic nucleic acid molecules, such as those that are chemically synthesized or recombinantly produced. Nucleic acid molecules can be double-stranded or single-stranded. Where single-stranded, the nucleic acid molecule can be the sense strand or the antisense strand. In addition, nucleic acid molecules can be circular or linear.

As used herein, the term “bacteria” encompasses both prokaryotic organisms and archaea present in mammalian microbiota. The terms “intestinal microbiota”, “gut flora”, and “gastrointestinal microbiota” are used interchangeably to refer to bacteria in the digestive tract. As used herein, the term “abundance” refers to the representation of a given phylum, order, family, or genera of microbe present in the gastrointestinal tract of a subject.

As used herein, the term “altering” as used in the phrase “altering the microbiota population” is to be construed in its broadest interpretation to mean a change in the representation of microbes in the subject. The change may be a decrease or an increase in the presence of a particular microbial species, genus, family, order, or class.

As used herein, the term “probiotic” refers to a composition containing substantially one species of bacteria (i.e., a single isolate), or a combination of substantially pure bacteria (i.e., a co-culture of desired bacteria), and may also include any additional carriers, excipients, and/or therapeutic agents that can be administered to a mammal for restoring microbiota. Probiotic compositions may be administered with a buffering agent to allow the bacteria to survive in the acidic environment of the stomach, that is, the bacteria resist low pH and are able to survive passage through the stomach in order to colonize and grow in the intestinal milieu. Buffering agents include, for example, sodium bicarbonate, milk, yoghurt, infant formula, and other dairy products. As used herein, a “co-culture” of bacteria refers to an in vitro culture of more than one bacterium. Such bacteria may be cultured with one or more activators or repressors. As used herein, the terms “activators” and “repressors” refer to agents that increase or decrease the number and/or activity of one or more desired bacteria, respectively.

“Patient” or “subject” as used herein refers to mammals and includes human and veterinary animals, a companion pet, a domestic animal species, or a wild animal.

As used herein, the terms “treating” and “treatment” of a medical condition include: preventing or delaying the appearance of at least one clinical or sub-clinical symptom of the medical condition developing in a subject that may be afflicted with or predisposed to the medical condition but does not yet experience or display clinical or subclinical symptoms of the medical condition; inhibiting the medical condition, i.e., arresting, reducing or delaying the development of the disease or a relapse thereof (in case of maintenance treatment) or at least one clinical or sub-clinical symptom thereof; and/or relieving the medical condition, i.e., causing regression of the state, disorder or condition or at least one of its clinical or sub-clinical symptoms. The benefit to a subject to be treated is either statistically significant or at least perceptible to the patient or to the physician. Treatment includes partial or full resolution of symptoms associated with the medical condition to be treated.

A “therapeutically effective amount” means the amount of a bacterial composition (probiotic) that, when administered to a subject for treating a medical condition, is sufficient to effect such treatment. The “therapeutically effective amount” will vary depending on the composition administered as well as the stage of the medical condition and its severity and the age, weight, physical condition and responsiveness of the subject to be treated.

As used herein, the phrase “pharmaceutically acceptable” refers to compositions that are generally regarded as physiologically tolerable to a patient.

As used herein, a bacterial co-culture and at least a second pharmaceutically active ingredient generally means at least two, but any desired combination of compounds that can be delivered simultaneously or sequentially (e.g., within a 4, 12, 24 hour or 1 week period).

The term “carrier” refers to a diluent, adjuvant, excipient, or vehicle with which a culture is administered. Such pharmaceutical carriers can be sterile liquids, such as water and oils, including those of petroleum, animal, vegetable or synthetic origin, such as peanut oil, soybean oil, mineral oil, sesame oil and the like. Water or aqueous solution, saline solutions and aqueous dextrose and glycerol solutions are preferably employed as carriers, particularly for injectable solutions. Alternatively, the carrier can be a solid dosage form carrier, including but not limited to one or more of a binder (for compressed pills), a glidant, an encapsulating agent, a flavorant, and a colorant. Suitable pharmaceutical carriers are described, for example, in “Remington's Pharmaceutical Sciences” by E. W. Martin.

As used herein, the term “metagenome” refers to genomic material obtained directly from a microbe or microbial population. As used herein, the term “metagenomics” refers to the application of modern genomics techniques to the study of communities of microbial organisms directly in their environment based on DNA obtained from a sample. Metagenomics provides information regarding the genomic material of a microbial community.

As used herein, a “microbiome” refers to the totality of microbes and their genetic elements (genomes) from a defined environment. A defined environment could, for example, be the gut of a human being or a soil sample. Thus, microbiome usually includes all area-specific microbiota and their complete genetic elements. The human microbiome contains over 10 times more microbes than genetically human cells.

As used herein, an “enterotype” refers to a classification of a living organism based on its bacteriological ecosystem in the human gut microbiome. Three human enterotypes are: Type 1 is characterized by high levels of Bacteroides while type 2 has few Bacteroides but Prevotella are common, and type 3 has high levels of Ruminococcus (P. Riedinger, 2010-2011 European Molecular Biology Laboratory Annual Report; www.embl.org).

As used herein, the term “metatranscriptomics” refers to RNA obtained from one or more cell populations and the assessment of genes that are transcribed in such populations. Metatranscriptomics assesses mRNA-derived cDNA to derive information with respect to the metabolic and functional capacity of a microbial community. A “transcriptome” is defined as the RNA that is transcribed from DNA that codes for proteins or is translated.

As used herein, “autoimmune disease” refers to, for example, rheumatism, rheumatoid arthritis, multiple sclerosis, neuro-autoimmune diseases (Guillain-Barre syndrome, neuro-Behcet's disease, etc.), type I (insulin-dependent) diabetes, systemic lupus erythematosus (SLE), Ankylosing Spondylitis, Bickerstaffs encephalitis, autoimmune pancreatitis, eczema, Celiac disease, Grave's disease, Myasthenia gravis, Scleroderma, and Sjogren's syndrome, which are known as intractable diseases (Clinical Immunology and Immunopathology, 84, 223-243 (1997)). Other autoimmune diseases are known in the art and are contemplated herein.

As used herein, “cancer” refers to any solid or blood-borne malignant or non-malignant uncontrolled growth of cells with or without attendant angiogenesis including but not limited to, a lymphoma, leukemia, a carcinoma, a sarcoma, a blastoma, or a germ cell tumor. Non-limiting examples of cancers include, for example, colon cancer, colorectal cancer, skin cancer, lung cancer, breast cancer, prostate cancer, pancreatic cancer, testicular cancer, bladder cancer, cervical cancer, ovarian cancer, stomach cancer, esophageal cancer, oral cancer, and gastric cancer. Other cancers are known in the art and are contemplated herein.

As used herein, a “metabolic condition” refers to a disorder of carbohydrate metabolism (e.g., glycogen storage disease), amino acid metabolism (e.g., phenylketonuria , maple syrup urine disease, glutaric acidemia type 1), organic acid metabolism(e.g., alcaptonuria), fatty acid oxidation and mitochondrial metabolism (e.g., Medium-chain acyl-coenzyme A dehydrogenase deficiency (MCADD)), porphyrin metabolism (e.g., acute intermittent porphyria), purine or pyrimidine metabolism (e.g., Lesch-Nyhan syndrome), steroid metabolism (e.g., congenital adrenal hyperplasia), mitochondrial function (e.g., Kearns-Sayre syndrome), peroxisomal function (e.g., Zellweger syndrome) or lysosomal storage (e.g., Gaucher's disease or Niemann Pick disease), obesity, metabolic syndrome, insulin-deficiency or insulin-resistance related disorders, ischemia, oxidative stress, atherosclerosis, hypertension, abnormal lipid metabolism, gastrointestinal reflux disease (GERD), and eosinophilic esophagitis.

As used herein, an “infection” refers to an overabundance of bacteria or viruses that cause a patient to be sick. Non-limiting example of bacterial infections to be treated include, but are not limited to, methicillin-resistant Staphylococcus aureus (MRSA), Clostridium difficile, Pseudomonas aeruginosa and vancomycin-resistant enterococci. Non-limiting viral infections include, for example, human immunodeficiency virus (HIV). Infections caused by other bacteria and viruses are also contemplated herein.

As used herein, an “inflammatory disease” refers to, for example, irritable bowel syndrome, ulcerative colitis, Crohn's disease, asthma and allergy.

As used herein, a “psychological disease” to refers to psychological conditions that are microbiome related, for example, attention deficit hyperactive disorder (ADHD), depression, bipolar disorder and autistic spectrum disorders.

### Diagnostic Methods of the Invention

Provided herein is a method of diagnosing the presence or absence of a medical condition in a mammal comprising: comparing, using at least a general purpose computer, a multiplex profile of a metatranscriptome profile and a metogenomic profile, from a sample from the mammal, to a multiplex profile of a population of patients diagnosed with said medical condition to determine the presence or absence of the medical condition. In one embodiment, the method further comprises isolating and quantifying at least a portion of 16S ribosomal RNA of the sample to determine the metagenomic profile of the sample. In another embodiment, the method further comprises isolating and quantifying at least a portion of messenger RNA of said sample to determine the metatranscriptome profile. In yet another embodiment, the method further comprises combining the metagenomic and metatranscriptome profiles into the multiplex profile using at least a general purpose computer.

Provided herein is a method of diagnosing the presence or absence of a medical condition in a mammal comprising: comparing, using at least a general purpose computer, a metatranscriptome profile from a sample from the mammal to the metatranscriptome of a population of patients diagnosed said medical Condition to determine the presence or absence of the medical condition. In one embodiment, the method further comprises isolating and quantifying at least a portion of messenger RNA of said sample to determine the metatranscriptome profile.

Provided herein is a method of diagnosing the presence or absence of a medical condition in a mammal comprising: comparing, using a general purpose computer, a multiplex profile of a metatranscriptome profile and a metogenomic profile, from a sample from the mammal, to a multiplex profile of a population of patients diagnosed with said medical condition to determine the presence or absence of the medical condition. In one embodiment, the method further comprises isolating and quantifying at least a portion of 16S ribosomal RNA of the sample to determine the metagenomic profile of the sample. In another embodiment, the method further comprises isolating and quantifying at least a portion of messenger RNA of said sample to determine the metatranscriptome profile. In yet another embodiment, the method further comprises combining the metagenomic and metatranscriptome profiles into the multiplex profile using a general purpose computer.

Provided herein is a method of diagnosing the presence or absence of a medical condition in a mammal comprising: comparing, using at least a general purpose computer, a metatranscriptome profile from a sample from the mammal to the metatranscriptome of a population of patients diagnosed said medical condition to determine the presence or absence of the medical condition. In one embodiment, the method further comprises isolating and quantifying at least a portion of messenger RNA of said sample to determine the metatranscriptome profile.

A mammal to be diagnosed with a method described herein includes, for example, a human, a veterinary animal (e.g., cows, horses, sheep, goats, etc.), a companion pet, a domestic animal species, a primate (e.g., gorillas, chimpanzees, monkeys, etc.) or a wild animal.

A medical condition to be diagnosed and/or treated with the disclosed methods can be, for example, a cancer, an infection, an inflammatory disease, an autoimmune disease, or a metabolic disease.

In one aspect, a cancer to be diagnosed and/or treated with the disclosed methods can be, for example, a leukemia, a lymphoma, a sarcoma or a carcinoma. Non-limiting examples of cancers include skin cancer, oral cancer, gastric cancer, pancreatic cancer, stomach cancer, colon cancer, gastrointestinal cancer, esophageal cancer, prostate cancer, testicular cancer, breast cancer and ovarian cancer.

In another aspect, an infection to be diagnosed and/or treated with the disclosed methods can be, for example, a bacterial infection. Non-limiting bacterial infections include Methicillin resistant Staphylococcus aureus (MSRA), Clostridium difficile, Pseudomonas aeruginosa or vancomycin-resistant enterococci.

In another aspect, an autoimmune disease to be diagnosed and/or treated with the disclosed methods can be, for example, multiple sclerosis, Ankylosing Spondylitis, Bickerstaffs encephalitis, autoimmune pancreatitis, eczema, Celiac disease, Grave's disease, Lupus erythematosus, Myasthenia gravis, Scleroderma, Sjögren's syndrome arthritis, or Rheumatoid arthritis.

In another aspect, an inflammatory disease to be diagnosed and/or treated with the disclosed methods can be, for example, irritable bowel syndrome, ulcerative colitis or Crohn's disease.

In another aspect, a metabolic disease to be diagnosed and/or treated with the disclosed methods can be, for example, a disorder of carbohydrate metabolism, amino acid metabolism, organic acid metabolism, fatty acid oxidation and mitochondrial metabolism, porphyrin metabolism, purine or pyrimidine metabolism, steroid metabolism, mitochondrial function, peroxisomal function or lysosomal storage.

In another aspect, a psychological condition to be diagnosed and/or treated with the disclosed methods can be, for example, attention deficit hyperactive disorder (ADHD), depression, bipolar disorder and autistic spectrum disorders.

Samples may be obtained by any conventional means. Samples include, but are not limited to, skin swab, skin biopsy, saliva, tooth swab, tooth scrapping, cheek swabs, throat swab, sputum, endogastric sample, feces, urine, vaginal, cervical, endocervical, endometrial, nasal swab, organ biopsy, and tissue biopsy. A sample may be one which is most connected with diagnosing a medical condition, for example, a fecal sample may be collected for diagnoses of colon cancer. It would be understood that more than one sample may be collected in order to diagnose a medical condition.

Quantifying 16S ribosomal RNA may be conducted using any conventional means including commercially available kits. Methods include, but are not limited to, quantitative polymerase chain reaction (PCR), microarray analysis, and next generation cDNA sequencing.

Quantifying messenger RNA may be conducted using any conventional means including commercially available kits. Methods include, but are not limited to a microarray/high-density array assay or an mRNA-derived cDNA clone library assay.

Provided herein are methods of diagnosing the presence or absence of a medical condition in a mammal comprising: obtaining a sample from said mammal; isolating and quantifying at least a portion of 16S ribosomal RNA (16S rRNA) of said sample to determine a metagenomic profile of the sample; isolating and quantifying at least a portion of messenger RNA of said sample to determine a metatranscriptome profile; combining the metagenomic and metatranscriptome profiles into a multiplex profile using a general purpose computer; and comparing the multiplex profile of said mammal to a multiplex profile of a population of patients diagnosed with said medical condition to determine the presence or absence of the medical condition using a general purpose computer. Such methods may also include comparing the multiplex profile of said mammal to a multiplex profile of a population of patients known to not have the medical condition.

Mammals to be diagnosed with the present methods include, for example, humans, veterinary animals, companion pets, a domestic animal species, and wild animals. Medical conditions to be diagnosed by such methods include, but are not limited to, a cancer, an infection, an inflammatory disease, an autoimmune disease, a psychological condition, or a metabolic disease.

Samples to be tested using the methods described herein include, but are not limited to, sample is selected from the group consisting of skin swab, skin biopsy, saliva, tooth swab, tooth scrapping, cheek swabs, throat swab, sputum, endogastric sample, feces, urine, vaginal, cervical, endocervical, endometrial, nasal swab, organ biopsy, and tissue biopsies. Samples may be obtained and preserved using conventional techniques known in the art.

Samples may be treated, if needed, prior to storage or further use. For example, heparin may be added to blood samples to prevent clotting. Tissue/biopsy samples and swabs may be immersed in a solution such as phosphate buffered saline (PBS) to suspend the cells prior to extraction of RNA.

Extraction of RNA from cells are generally carried out using methods known in the art. Physical and/or chemical cell lysis and affinity column purification is used to extract RNA from the organisms or cells or tissue samples. For example, total RNA can be is isolated using an RNEASY 96™ kit and buffers purchased from Qiagen Inc. (Valencia, Calif.) following the manufacturer's recommended procedures. Briefly, for cells grown on 96-well plates, growth medium are removed from the cells and each well is washed with 200 μL cold PBS. 150 μL Buffer RLT is added to each well and the plate is vigorously agitated for 20 seconds. 150 μL of 70% ethanol is then added to each well and the contents mixed by pipetting three times up and down.

The samples are then transferred to the RNEASY 96™ well plate attached to a QIAVAC™ manifold fitted with a waste collection tray and attached to a vacuum source. Vacuum is applied for 1 minute. 500 μL of Buffer RW1 is added to each well of the plate and incubated for 15 minutes and the vacuum is again applied for 1 minute. An additional 500 μL of Buffer RW1 is added to each well of the plate and the vacuum is applied for 2 minutes. 1 mL of Buffer RPE is then added to each well of the plate and the vacuum applied for a period of 90 seconds. The Buffer RPE wash is then repeated and the vacuum is applied for an additional 3 minutes. The plate is then removed from the manifold and blotted dry on paper towels. The plate is then re-attached to the manifold fitted with a collection tube rack containing 1.2 mL collection tubes. RNA is then eluted by pipetting 140 μL of RNAse free water into each well, incubating 1 minute, and then applying the vacuum for 3 minutes. The repetitive pipetting and elution steps may be automated using a QIAGEN Bio-Robot 9604 (Qiagen, Inc., Valencia Calif.). Essentially, after lysing of the cells on the culture plate, the plate is transferred to the robot deck where the pipetting, DNase treatment and elution steps are carried out.

Ribosomal RNA sequencing has also been used to study spatial variability in similar environments, both for complete microbial communities and for specific components of those communities. Various methods of assessing the 16S rRNA content of a sample and taxonomic analysis of samples are known in the art and include, but are not limited to the methods described herein.

Dedicated 16S databases and tools have been developed (e.g., Cole J R, et al., The ribosomal database project (RDP-II): introducing myRDP space and quality controlled public data. Nucleic Acids Res 2007, 35:D169-172; DeSantis T Z, et al., Greengenes, a chimera-checked 16S rRNA gene database and workbench compatible with ARB. Appl Environ Microbiol 2006, 72:5069-5072; and Pruesse E, et al.: SILVA: a comprehensive online resource for quality checked and aligned ribosomal RNA sequence data compatible with ARB. Nucleic Acids Res 2007, 35:7188-7196, greengenes.lbl.gov).

16S rRNA Analysis

Screening of 16S rRNA genes permits characterizing microorganisms present in the microbiota at the species, genus, family, order, class, or phylum level. Useful molecular techniques for the purposes of the present screening of microbial 16S rRNA include PCR. Broad-range PCR primers targeted to highly conserved regions makes possible the amplification of small subunit rRNA gene sequences from all bacterial species (Zoetendal et al., (2006) Mol Microbial 59, 1639-1650), and the extensive and rapidly growing 16S database facilitates identification of sequences to the species or genus level (Schloss and Handelsman, (2004) Microbiol Mol Biol Rev 68, 686-691). Such techniques can also be used for identifying bacterial species in complex environmental niches (Smit et al., (2001) Appl Environ Microbiol 67, 2284-2291), including the human mouth, esophagus, stomach, intestine, feces, skin, and vagina, and for clinical diagnosis (Harris and Hartley, (2003) J Med Microbiol 52, 685-691; Saglani et al., (2005) Arch Dis Child 90, 70-73).

Methods of quantitative PCR are known in the art and are contemplated for use herein. Commercially distributed kits are also available. Other methods of assessing 16S rRNA include, for example, microarray analysis, and next generation cDNA sequencing. 16S data may be generated at an increased rate due to new and improved sequencing technologies that dramatically increase throughput and decrease cost. These include lower Sanger sequencing costs as well as inexpensive 454 pyrosequencing and the PhyloChip, a custom microarray for 16S surveys.

454 pyrosequencing technology has been adapted for 16S analysis, by PCR-amplifying the short V6 variable region of the bacterial 16S rRNA gene using universal primers and running them separately within a single 454 run (Sogin et al., Proc Natl Acad Sci USA 2006, 103:12115-12120). This single run generated a total of ˜118,000 sequence tags (“16S pyrotags”).

Second generation pyrosequencing technology (454-FLX) produces average read lengths of more than 200 by and yields ˜100 Mb per run, and the third generation of pyrosequencing (titanium) has recently appeared on the scene producing ˜500 Mb per run and average read lengths >400 bp. These enhancements will continue to improve the throughput and resolution of 16S pyrotag investigations (Liu et al., Nucleic Acids Res 280 (2007), 35:e120). Barcoding, in which sequences from particular samples can be identified by unique sequences incorporated into the amplification primers, has enabled multiplexing of samples within runs and has further enhanced the usefulness of this approach (Parameswaran et al., Nucleic Acids Res 2007, 35:e130; and Hamady et al., Nat Methods 2008, 5:235-237).

Another method 16S analysis does not depend upon DNA sequencing, but rather, involves a high-density microarray of phylogenetically specific probes called the PhyloChip. DeSantis et al. (Microb Ecol 2007, 53:371-383) have been able to use such microarrays to accurately differentiate among phylotypes in diverse environmental samples, documenting not only the vast majority of taxa identified by traditional cloning and sequencing but also groups not seen in clone libraries that were subsequently confirmed by taxon-specific PCR.

In one embodiment, 16S rRNA phylogenetic probes are provided on a microarray chip, such as the G2 Phylochip or the G3 Phylochip available from Second Genome, Inc. (San Francisco, Calif.) and Affymetrix (Santa Clara, Calif.).

Fragmentation of the RNA is often carried out using enzymes, chemicals or heat or any combination of these. A fraction or aliquot of the fragmented RNA is labeled with a fluorescent label for suitable detection or with a label having a known binding partner to which a detectable label can be attached. In another embodiment, the fragmented RNA is labeled with a fluorescent molecule such as Alexafluor 546. In some embodiments, the fragmented RNA is labeled with biotin to which a fluorescently labeled streptavidin can be bound.

After labeling a fraction of the RNA, hybridization of the fragmented labeled RNA to a set of oligonucleotide probes is carried out. The set of oligonucleotide probes is typically attached to a solid planar substrate or on a microarray slide. However, it is contemplated that the probes may be attached to spheres, or other beads or other types of substrates. The substrates often made of materials including but not limited to, silicon, glass, metals or semiconductor materials, polymers and plastics. The substrates may be coated with other metals or materials for specific properties. In one embodiment, the substrate is coated with indium tin oxide (ITO) to provide a conductive surface for NanoSIMS analysis. The oligonucleotide probes may be present in other analysis systems, including but not limited to bead or solution multiplex reaction platforms, or across multiple platforms, for example, Affymetrix GeneChip® Arrays, Illumina BeadChip® Arrays, Luminex xMAP® Technology, Agilent Two-Channel Arrays, MAGIChips (Analysis systems of Gel-immobilized Compounds) or the NanoString nCounter Analysis System. The Affymetrix (Santa Clara, Calif., USA) platform DNA arrays can have the oligonucleotide probes (approximately 25 mer) synthesized directly on the glass surface by a photolithography method at an approximate density of 10,000 molecules per μm2 (Chee et al., Science (1996) 274:610-614). Spotted DNA arrays use oligonucleotides that are synthesized individually at a predefined concentration and are applied to a chemically activated glass surface. The oligonucleotide probes are probes generally of lengths that range from a few nucleotides to hundreds of bases in length, but are typically from about 10-mer to 50-mer, about 15-mer to 40-mer, or about 20-mer to about 30-mer in length.

In one embodiment, the oligonucleotide probes is a set of phylogenetic probes. In another embodiment, the phylogenetic probes comprising 16S rRNA phylogenetic probes.

Features of phylogenetic microarrays include the use of multiple oligonucleotide probes for every known category of prokaryotic organisms for high-confidence detection, and the pairing of at least one mismatch probe for every perfectly matched probe to minimize the effect of nonspecific hybridization. In some embodiments, each perfect match probe corresponds to 1, 2, 3, 4, 5, 6, 7, 8, 9, 10, 11, 12, 13, 14, 15, 16, 17, 18, 19, 20, or more mismatch probes. These and other features, alone or in combination as described herein, make arrays of the invention extremely sensitive, allowing identification of very low levels of microorganisms.

Methods to design and select suitable probes and arrays for Chip-SIP analysis are described in detail in US20090291858A1, which is incorporated by reference with respect to the Chip-SIP analysis.

In one embodiment, the 16s rRNA phylogenetic probes are provided on a microarray chip, such as the G2 Phylochip or the G3 Phylochip available from Second Genome, Inc. (San Francisco, Calif.) and Affymetrix (Santa Clara, Calif.).

Again, the RNA that is hybridized to the probes are then imaged to detect hybridization signal strength and thereby quantify the labeled RNA to determine the community organism composition and also to correct and normalize the isotope signals in the RNA bound to each probe.

In one embodiment, for analysis for microbial composition and normalization of isotope signals, microarrays hybridized with fluorescent/biotin labeled RNA are imaged with a fluorescence scanner and fluorescence intensity measured for each probe feature or “spot”. Arrays can be scanned using any suitable scanning device. Non-limiting examples of conventional microarray scanners include GeneChip Scanner 3000 or GeneArray Scanner, (Affymetrix, Santa Clara, Calif.); and ProScan Array (Perkin Elmer, Boston, Mass.); and can. be equipped with lasers having resolutions of 10 pm or finer. The scanned image displays can be captured as a pixel image, saved, and analyzed by quantifying the pixel density (intensity) of each spot on the array using image quantification software (e.g., GeneChip Analysis system Analysis Suite, version 5.1 Affymetrix, Santa Clara, Calif.; and ImaGene 6.0, Biodiscovery Inc. Los Angeles, Calif., USA). For each probe, an individual signal value can be obtained through imaging parsing and conversion to xy-coordinates. Intensity summaries for each feature can be created and variance estimations among the pixels comprising a feature can be calculated.

With flow cytometry based detection systems, a representative fraction of microparticles in each sublot of microparticles can be examined. The individual sublots, also known as subsets, can be prepared so that microparticles within a sublot are relatively homogeneous, but differ in at least one.distinguishing characteristic from microparticles in any other sublot. Therefore, the sublot to which a microparticle belongs can readily be determined from different sublots using conventional flow cytometry techniques as described in U.S. Pat. No. 6,449,562. Typically, a laser is shone on individual microparticles and at least three known classification parameter values measured: forward light scatter (C₁) which generally correlates with size and refractive index; side light scatter (C₂) which generally correlates with size; and fluorescent emission in at least one wavelength (C₃) which generally results from the presence of fluorochrome incorporated into the labeled target sequence. Because microparticles from different subsets differ in at least one of the above listed classification parameters, and the classification parameters for each subset are known, a microparticle's sublot identity can be verified during flow cytometric analysis of the pool of microparticles in a single assay step and in real-time. For each sublot of microparticles representing a particular probe, the intensity of the hybridization signal can be calculated along with signal variance estimations after performing background subtraction.

In one embodiment, responsive probe-sets are then identified based on set criteria. For example, when using the Phylochip array of probes, the responsive probe sets are identified based on probability of probe intensities originating in the positive or background intensity distributions. High confidence subfamilies are identified with expected 98.4% True Positive Rate and 2.4% False Positive Rate. Probes targeting most probable taxa in high confidence subfamilies are ranked based on quality criteria such as the lowest potential for cross-hybridization across network of putatively present taxa and the greatest difference between Perfect Match (PM) and Mismatch (MM) probe intensities. Ranked PM probes plus corresponding MM probes are synthesized onto an array and then hybridized to a reserved fraction of the RNA isolated from the organism or sample.

Various methods of mass spectrometry may be used in addition to detection using the present phylogenetic probes, such as nanoSIMS (nanoscale secondary ion mass spectrometry) or time-of-flight secondary ion mass spectrometry or other methods or means of spectrometry or spectroscopy. In other embodiments, the use of spectroscopic methods that may be employed include Raman spectroscopy or reflectance or absorbance spectroscopy. In one preferred embodiment, for analysis of isotope incorporation into organisms, microarrays hybridized with non-fluorescently labeled RNA are imaged with a secondary ion mass spectrometer, such as a SIMS or NanoSIMS device. In a specific embodiment, the NanoSIMS device is a NimbleGen MAS and the probe array is synthesized onto ITO-coated slides suitable for NanoSIMS analysis.

In some embodiments, sequence information generated from reverse-transcribed RNA (cDNA) from the same samples is used to select unique regions for probe design.

In another embodiment, the array of probes is synthesized on a substrate coated with Indium Tin Oxide (ITO) to provide a conductive surface for NanoSIMS analysis. For example, ranked PM probes plus corresponding MM probes are synthesized using the NimbleGen MAS on ITO-coated slides suitable for NanoSIMS analysis.

Unidimensional diversity indices and total operational taxonomic unit (OTU) estimates used in single-sample studies may be used in addition to tools designed to directly compare communities found in different samples.

Once sequences have been grouped into OTUs based on some set of similarity criteria (e.g. using DOTUR (Schloss and Handelsman, Applied Environ Microbiol., 2005, 71:1501-1506)), similarity indices such as Bray-Curtis can be calculated to estimate the relatedness of different communities. Regression techniques can then be applied to isolate variables that contribute significantly to community composition, as well as correlate the abundances of specific phylogenetic groups with environmental factors (Brodie et al. Proc Natl Acad Sci USA, 2007, 104:299-304).

A recent technique for 16S sequence analysis is UniFrac, a program designed to determine the fraction of unique branch lengths within a phylogenetic tree (comprising sequences from multiple samples) that is attributable to a particular sample (Lozupone and Knight, Appl Environ Microbiol, 2005, 71:8228-8235). Once this is determined, principal coordinates analysis (PCoA) can be used to identify specific environmental variables that drive differences among communities (Lozupone and Knight, Proc Natl Acad Sci USA, 2007, 104:11436-11440). One advantage of this approach is that it deals entirely with tree-based metrics. Thus, differences at the species or genus level receive less weight than those at the phylum level, but are still considered in the overall analysis. Weighted UniFrac, assigning weights to branches of the tree, is based on the abundance of specific phylotypes.

Other methods of assessing 16S rRNA profiles of samples and analyzing the results thereof are known in the art and are contemplated for use herein.

Metatranscriptomics

Metatranscriptomic methods are those which detect over- and under-represented transcribed genes in the total bacterial population. Screening of transcribed genes permits characterization of the metabolism and functional capabilities of microorganisms present in a community. As described above, the present inventors have identified the use of metatranscriptomics to more closely assess which microbial genes may be involved with, or the cause of, a medical condition. Metagenomics looks at the total genomic material of a microbial sample, but does not provide any information with respect to the metabolic activity or functional capacity of the community. Thus, the methods identified for the first time by the present inventors address the inadequacies of a metagenomic approach to assessment of medical conditions and provide information regarding the regulation of microbial gene expression in response to a medical condition.

Methods of metatranscriptomics include, for example, microarray/high-density array technology and mRNA-derived cDNA clone libraries.

For microarray/high-density array metatranscriptome analysis of a sample, RNA is isolated to represent the metatranscriptome of the samples. Briefly, samples are taken and centrifuged (1,000×g for 5 min) to remove solids. The supernatant is centrifuged for a second time (5,000×g for 15 min), and the metatranscriptome RNA is isolated from the resulting cell pellet by applying an enzymatic cell lysis using mutanolysin and lysozyme, after which the RNA is extracted from the resulting mixture by using an RNeasy minikit (Qiagen) following standard instructions and including mechanical disruption of the cells using glass beads according to manufacturer's instructions.

A LAB functional gene microarray is used, typically containing ˜2,269 oligonucleotides that target in total ˜406 key genes (Weckx et al., 2009. Appl. Environ. Microbiol. 75:6488-6495.). The isolated RNA is linearly amplified (aRNA) using a Genisphere SensAmp kit (Genisphere, Hatfield, Pa.), labeled with Cy3 and Cy5 dyes in a reverse transcription reaction, and 60 pmol of labeled aRNA is hybridized for 16 hours (h) using a HS 4800 Pro automated hybridization station (Tecan Systems, Inc., San Jose, Calif.). The labeled aRNA of the samples is hybridized to the microarray, using a loop design over the different time points: i.e., two consecutive samples (e.g., 27 h and 51 h, 51 h and 75 h, etc.) are hybridized on the same microarray slide, each labeled with another fluorescent dye (Cy3 and Cy5), and the loop is closed by hybridizing the last sample together with the first.

Each oligonucleotide is spotted four times on the array and each sample is hybridized twice (i.e., once labeled with Cy3 and once labeled with Cy5), thus, the intensity of each oligonucleotide is measured eight times. The intensity of an oligonucleotide is considered above background level if the intensities of at least six out of eight spots are above the background level. Intensity values are normalized for array and dye effects, and those oligonucleotides with a significant change in their hybridization intensity profile over time are retained for clustering.

The hybridization intensity profiles are transformed into Z-score profiles by subtracting the average hybridization intensity of all oligonucleotides from the hybridization intensity of the oligonucleotide considered and dividing that result by the standard deviation of all hybridization intensities. Then, the Z-score profiles are hierarchically clustered with the complete linkage option with a distance measure of one minus the Pearson correlation.

To indicate the species present in the samples, a significance per species of at least 10% is typically reached: i.e., at least 10% of the species-specific oligonucleotides (with a minimum of two oligonucleotides) has an intensity above background. This percentage is based on the outcome of validation hybridizations using DNA and RNA of 18 LAB strains, covering 86% of all oligonucleotides on the microarray, whereby the highest number of false-positive signals appeared to be 6%. Species that are represented by at least 10 oligonucleotides are considered for further analysis.

Other methods of microarray/high-density array metatranscriptome analysis are known in the art and may be used in the methods herein. Representative methods include those taught by, for example, He et al., Environ. Microbiol., 12: 1205-1217 (2010), and Parro et al. Environ. Microbiol., 9:435-464 (2007).

A second type of metatranscriptome analysis involves mRNA-derived cDNA libraries. Poretsky et (Appl. Environ. Microbiol. 71: 4121-4126 (2005)) developed a protocol to analyze partial environmental transcriptomes by collecting total RNA from the environment, enriching for mRNA by subtractive hybridization of rRNA, and using randomly primed reverse transcription (RT) to produce a cDNA template population. The templates are amplified by PCR and used to generate cDNA clone libraries. Briefly, samples are collected and screened immediately after collection to remove particles of >3.0 pm, including most eukaryotic cells. Cells for RNA extraction are collected on a 0.2-pm-pore-size polycarbonate membrane filter. Samples are stored on ice during transport to the laboratory and then filtered onto a 0.2-pm-poresize membrane filter. The process from sample collection to RNA extraction is done as rapidly as possible to limit degradation of mRNA. RNA may be extracted using, for example, a RNAqueous-Midi kit (Ambion, Austin, Tex.).

Subtractive hybridization is used to selectively remove rRNA (MICROBExpress Bacterial mRNA enrichment kit; Ambion). DNase-treated mRNA preparations are amplified by RT-PCR using random primers. Clone libraries PCR products are screened to eliminate sequences derived from contaminating rRNA using probes constructed by amplifying rRNA genes from DNA harvested from the same sample. Sequences of clones may be analyzed using, for example, the BLASTX and BLASTN tools (www.ncbi.nlm.nih.gov/BLAST/). Additionally, clones may be automatically annotated using the Annotation Engine service provided by The Institute for Genomic Research (Rockville, Md.).

Standard cloning and sequencing methods used for manually assembled libraries may be readily adapted to high-throughput approaches, potentially allowing the sequencing of thousands of amplicons from a single community.

Sub-libraries may be generated from a single sample using different primer combinations, with one primer chosen at random for the RT step and that primer used in combination with a second primer in the PCR step.

Putative taxonomic origin of the transcripts is used to assess diversity in relation to the known microbial compositions of diseased and normal patient populations. Putative taxonomic origin is assigned based on the taxon of the most similar sequence by BLAST analysis.

Some of the sequences obtained may not be full-length transcripts. Analysis can be compared to controls that lack the RT step in which no amplification should be observed. mRNA sequences may be transcribed, for example, from a range of housekeeping genes, components of transport systems, and genes for energy metabolism. Like taxonomic assignments, the identities of transcripts may be inferred from the closest matches by BLASTX.

Other methods for mRNA-derived cDNA library metatranscriptomics are known in the art and may be used in the methods herein. Representative methods include those taught by, for example, Tartar et al. Biotechnol. Biofuels, 2:25 (2009).

Multiplex Profiles and Diagnosis

Multiplex profiles provided herein may be generated by conventional means in the art. For example, data with respect to microorganism 16S rRNA levels in a sample may be combined with metatranscriptome data from a sample to provide a profile which profile may be represented in a table, graphically or schematically.

FIG. 1 provides an exemplary visual depiction of the development of a profile for a medical condition in which the relative abundance of the phylogenetic data is ranked on the X-axis as −log data with the mean thus being zero; the relative abundance of the mRNA is ranked along the Y-axis as −log data with the mean thus being zero; the medical condition is characterized by an increase in species/mRNA and a decrease in species/mRNA.

Metatranscriptomics as described herein provides a means to restore friendly flora in a patient to treat a medical condition associated with an imbalance of the flora. Metatranscriptomics also provides the means to distinguish between friendly flora and unfriendly flora based upon the microbes present in the flora and the genes that are being transcribed at levels higher or lower than normal and then determines the roles of the microbes. Such assessments provide means for diagnosing medical conditions more accurately than the sole assessment of the metagenome of a sample obtained from a patient.

Exemplary Methods of Diagnosis

In one aspect, provided herein is a method of diagnosing the presence or absence of a medical condition in a mammal comprising: obtaining a sample from said mammal; isolating and quantifying at least a portion of 16S ribosomal RNA of said sample to determine a metagenomic profile of the sample; isolating and quantifying at least a portion of messenger RNA of said sample to determine a metatranscriptome profile; combining the metagenomic and metatranscriptome profiles into a multiplex profile using a general purpose computer; and comparing the multiplex profile of said mammal to a multiplex profile of a population of patients diagnosed with said medical condition to determine the presence or absence of the medical condition using a general purpose computer.

In another aspect, provided herein is a method of diagnosing the presence or absence of a medical condition in a mammal comprising: obtaining a sample from said mammal; isolating and quantifying at least a portion of the messenger RNA contained in said sample to determine the metatranscriptome; and comparing the metatranscriptome of said mammal to the metatranscriptome of a population of patients diagnosed said medical condition to determine the presence or absence of the medical condition.

Other methods of diagnosing medical conditions are described elsewhere herein. In one embodiment, comparisons are conducted using a general purpose computer.

Antibiotic treatment has been widely observed to disturb gastrointestinal microflora resulting in a range of clinical symptoms including diarrhea. Dysbiosis encompasses a diagnosis of intestinal flora that has harmful effects and can be caused by putrefaction, fermentation, deficiency and/or sensitization. Several diseases within the bowel or involving skin and connective tissue, in addition to hormonal and metabolic diseases have been reported in association with dysbiosis.

The major mucosal organisms are coccobacilli and streptococci; the predominant organisms of the lumen are yeasts and Lactobacilli. In the colon, spirochetes and fusiform bacteria predominate the mucosal surface and anaerobic rods like Eubacterium, Bacteroides and Bifidobacterium dominate the lumen. Some indices of dysbiosis include, for example, a lack of Lactobacillus or of E. coli on stool culture, or high levels of uncommon or atypical Enterobacteriaceae or of Klebsiella, Proteus or Pseudomonas.

Intestinal dysbiosis may act as mechanism promoting disease in patients with chronic gastrointestinal, inflammatory or autoimmune disorders, food allergy/intolerance, breast and colon cancer, and unexplained fatigue, malnutrition or neuropsychiatric symptoms. In certain cases, excess cholesterol or fatty acids may be indicative of malabsorption because bacterial overgrowth can interfere with micelle formation.

Fermentation is a condition of carbohydrate intolerance induced by overgrowth of endogenous bacteria in the stomach, small intestine and cecum. Fermentation may cause damage to the stomach, small intestine and cecum.

Provided herein is a method of diagnosing a patient with the presence or absence of Antibiotic-Induced Dysbiosis where the method comprises obtaining a fecal sample from a patient, isolating and quantifying at least a portion of 16S rRNA of the sample to determine a metagenomic profile of the sample; isolating and quantifying at least a portion of mRNA of the sample to determine a metatranscriptome profile; combining the metagenomic and metatranscriptome profiles into a multiplex profile using a general purpose computer; and comparing the multiplex profile of said mammal to a multiplex profile of a population of patients diagnosed with Antibiotic-Induced Dysbiosis to determine the presence or absence of Antibiotic-Induced Dysbiosis using a general purpose computer. In one embodiment, the multiplex profile identifies a lower than normal amount of DNA and RNA associated with the phyla associated with the distal gut including Bacteroidetes, Firmicutes, Proteobacteria, Actinobacteria, Verrucomicrobia and Clostridiales and the patient is diagnosed with Antibiotic-Induced Dysbiosis. The multiplex profile may also be compared in some instances to a multiplex profile of a population of patients identified as not having Antibiotic-Induced Dysbiosis. In one embodiment, the patient is a child and the child is diagnosed with the presence or absence of Pediatric Antibiotic-Induced Dysbiosis.

Provided herein is a method of diagnosing colon cancer in a patient comprising: obtaining a stool sample, isolating and quantitating the 16S rRNA of the sample, isolating and quantitating the mRNA of the sample, preparing a multiplex profile of the 16S rRNA and mRNA and comparing the multiplex profile of the patient to the multiplex profile of a population of patients known to have colon cancer and/or to a population of patients known to not have colon cancer. In one embodiment, the 16S rRNA assessment identifies an increase in Bacteroides, Proteus and Klebsiella species compared to control patients who do not have colon cancer or levels similar to control patients who do have colon cancer. In another embodiment, the mRNA assessment identifies an increase in urease gene transcription compared to control patients who do not have colon cancer or levels similar to control patients who do have colon cancer. Further diagnostics of a patient having colon cancer can include for example, identification of an increase in pH of the stool sample and an increase in urea and ammonia levels.

Provided herein is a method of diagnosing a patient with cirrhosis comprising: obtaining a urine sample, isolating and quantitating the 16S rRNA of the sample, isolating and quantitating the mRNA of the sample, preparing a multiplex profile of the 16S rRNA and mRNA and comparing the multiplex profile of the patient to the multiplex profile of a population of patients known to have cirrhosis and/or to a population of patients known to not have cirrhosis. In one embodiment, the 16S rRNA assessment identifies an increase in Bacteroides, Proteus and Klebsiella species compared to control patients who do not have cirrhosis or levels similar to control patients who do have cirrhosis. In another embodiment, the mRNA assessment identifies an increase in decarboxylase gene transcription compared to control patients who do not have cirrhosis or levels similar to control patients who do have cirrhosis. Further diagnostics of a patient having cirrhosis can include for example, identification of an increase in vasoactive and neurotoxic amines including, for example, histamine, octopamine, tyramine and tryptamine in systemic circulation in the patient.

Provided herein is a method of diagnosing a patient with cancer comprising: obtaining a sample, isolating and quantitating the 16S rRNA of the sample, isolating and quantitating the mRNA of the sample, preparing a multiplex profile of the 16S rRNA and mRNA and comparing the multiplex profile of the patient to the multiplex profile of a population of patients known to have cancer and/or to a population of patients known to not have cancer. In one embodiment, the 16S rRNA assessment identifies an increase in Bacteroides, Proteus and Klebsiella species compared to control patients who do not have cancer or levels similar to control patients who do have cancer. In another embodiment, the mRNA assessment identifies an increase in tryptophanase gene transcription compared to control patients who do not have cancer or levels similar to control patients who do have cancer. Further diagnostics of a patient having cancer can include for example, identification of an increase in carcinogenic phenols in the patient or the presence of Matrix Metalloproteinases (MMPs) in samples taken from said patient.

Provided herein is a method of diagnosing a patient with breast cancer comprising: obtaining a stool, blood and/or urine sample, isolating and quantitating the 16S rRNA of the samples, isolating and quantitating the mRNA of the samples, preparing a multiplex profile of the 16S rRNA and mRNA and comparing the multiplex profile of the patient to the multiplex profile of a population of patients known to have breast cancer and/or to a population of patients known to not have breast cancer. In one embodiment, the 16S rRNA assessment identifies an increase in Bacteroides, Proteus and Klebsiella species compared to control patients who do not have breast cancer or levels similar to control patients who do have breast cancer. In another embodiment, the mRNA assessment identifies an increase in beta-glucoruonidase gene transcription compared to control patients who do not have breast cancer or levels similar to control patients who do have breast cancer. Further diagnostics of a patient having cancer can include for example, identification of an increase in deconjugating enzymes in the stool, lower estrogen levels in the stool, and an increase in estrogen or MMP levels in blood and urine of the patient.

Provided herein is a method of diagnosing fermentation or carbohydrate intolerance in a patient comprising: obtaining a stool sample, isolating and quantitating the 16S rRNA of the sample, isolating and quantitating the mRNA of the sample, preparing a multiplex profile of the 16S rRNA and mRNA and comparing the multiplex profile of the patient to the multiplex profile of a population of patients known to have fermentation or carbohydrate intolerance and/or to a population of patients known to not have fermentation or carbohydrate intolerance. In one embodiment, the mRNA assessment identifies an increase in bacterial protease gene transcription compared to control patients who do not have fermentation or carbohydrate intolerance or levels similar to control patients who do have fermentation or carbohydrate intolerance. Further diagnostics of a patient having colon cancer can include for example, identification of degradation of pancreatic and intestinal brush border enzymes, pancreatic insufficiency, mucosal damage and malabsorption.

Provided herein is a method of diagnosing irritable bowel syndrome in a patient comprising obtaining a stool sample from said patient, isolating and quantitating the 16S rRNA of the sample, isolating and quantitating the mRNA of the sample, preparing a multiplex profile of the 16S rRNA and mRNA and comparing the multiplex profile of the patient to the multiplex profile of a population of patients known to have irritable bowel syndrome and/or to a population of patients known to not have irritable bowel syndrome.

The present methods may be used to characterize specific changes in mammalian bacterial gastrointestinal microbiota (on the phylum, class, order, family, genus, and species level) which occur upon treatment with sub-therapeutic doses of antibiotics, where treatment is associated with (i) increased % body fat and adipose tissue deposition and with (ii) increased bone mineral density (BMD) at early stages of life. Such specific antibiotic and/or obesity-associated changes in mammalian bacterial gastrointestinal microbiota constitute diagnostics which can be used to determine whether a given mammal is likely to develop obesity and/or short stature.

Provided herein is a method of diagnosing obesity and related disorders in a patient comprising obtaining a stool sample from said patient, isolating and quantitating the 16S rRNA of the sample, isolating and quantitating the mRNA of the sample, preparing a multiplex profile of the 16S rRNA and mRNA and comparing the multiplex profile of the patient to the multiplex profile of a population of obese patients or having a related disorder and/or to a population of non-obese patients or patients known to not have a related disorder.

### Therapeutic Methods of the Invention

Provided herein is a method of treating a patient diagnosed with a medical condition as described above, comprising identifying an imbalance of microbes in a sample from said patient; and restoring or correcting disease- or medical condition-related imbalances in the patient's microbiome, based on the information revealed by the patient's microbiome profile, with culture-conditioned formulations in which the transcriptome activity of the administered organisms is optimized.

Therapeutic approaches described herein are designed to restore the normal flora. In one embodiment, probiotic culture is administered to the patient, quickly conditions the microbial community at the site of treatment and restores a healthy flora, prior to elimination from the body. Table 1 provides an exemplary identification of bacteria typically found on the surfaces of the human body.

| | | | | | | Lower | Ant. | |
|---|---|---|---|---|---|---|---|---|
| BACTERIUM | Skin | Conjunctiva | Nose | Pharynx | Mouth | GI | urethra | Vagina |
| Staphylococcus epidermidis | ++ | + | ++ | ++ | ++ | + | ++ | ++ |
| Staphylococcus aureus* | + | +/− | + | + | + | ++ | +/− | + |
| Streptococcus mitis | | | | + | ++ | +/− | + | + |
| Streptococcus salivarius | | | | ++ | ++ | | | |
| Streptococcus mutans* | | | | + | ++ | | | |
| Enterococcus faecalis* | | | | +/− | + | ++ | + | + |
| Streptococcus pneumoniae* | | +/− | +/− | + | + | | | +/− |
| Streptococcus pyogenes* | +/− | +/− | | + | + | +/− | | +/− |
| Neisseria sp. | | + | + | ++ | + | | + | + |
| Neisseria meningitidis* | | | + | ++ | + | | | + |
| Enterobacteriaceae* | | +/− | +/− | +/− | + | ++ | + | + |
| (Escherichia coli) | | | | | | | | |
| Proteus sp. | | +/− | + | + | + | + | + | + |
| Pseudomonas aeruginosa* | | | | +/− | +/− | + | +/− | |
| Haemophilus influenzae* | | +/− | + | + | + | | | |
| Bacteroides sp.* | | | | | | ++ | + | +/− |
| Bifidobacterium bifidum | | | | | | ++ | | |
| Lactobacillus sp. | | | | + | ++ | ++ | | ++ |
| Clostridium sp.* | | | | | +/− | ++ | | |
| Clostridium tetani | | | | | | +/− | | |
| Corynebacteria | ++ | + | ++ | + | + | + | + | + |
| Mycobacteria | + | | +/− | +/− | | + | + | |
| Actinomycetes | | | | + | + | | | |
| Spirochetes | | | | + | ++ | ++ | | |
| Mycoplasmas | | | | + | + | + | +/− | + |

Potential pathogens are denoted by an asterisk; “++” indicates that the bacterium represents nearly 100% of the population; “+” indicates that the bacterium represents ~25% of the population; and “+/−” indicates that the bacterium represents less than 5% of the population. Kenneth Todar, Ph.D., Online Textbook of Bacteriology, ©2011; www.textbookofbacteriology.net/normalflora.html.

Pharmaceutical Compositions

Techniques for cultivation of microorganisms include those, for example, described in the Manual of Clinical Microbiology, 8th edition; American Society of Microbiology, Washington D.C., 2003. Bacterial co-cultures may be cultured according to standard practices.

As described above, FIG. 1 provides an exemplary visual depiction of the development of a profile for a medical condition in which the relative abundance of the phylogenetic data is ranked on the X-axis as −log data with the mean thus being zero; the relative abundance of the mRNA is ranked along the Y-axis as −log data with the mean thus being zero; the medical condition is characterized by an increase in species/mRNA and a decrease in species/mRNA.

Provided herein are formulations for treatment of medical condition designed to increase the species and to increase the transcripts found in the upper, right field of an assessment exemplified by FIG. 1 and/or to decrease the species and to decrease the transcripts in the lower right field of an assessment exemplified by FIG. 1.

Provided herein is a method of manufacturing a probiotic formulation such that the conditions of the fermentation stage of manufacture replicate the conditions found in particular parts of the body (e.g., the distal gut) with particular reference to the relative composition of microorganisms.

Probiotic cultures described herein may include one or more of the bacteria described in Table 1 in an amount designed to restore a healthy flora to a particular area of the body of the patient being treated. Thus, the probiotic culture described herein efficiently restores healthy levels of native bacterial species in the relative amounts found in healthy flora. The restoration of the native bacterial species also inhibits the growth of harmful species of bacteria.

In one embodiment a probiotic formulation to be used to readjust the distal gut of a patient suffering from dysbiosis, is manufactured using a process in which Bacteroidetes, Firmicutes, Proteobacteria, Actinobacteria, Verrucomicrobia and Clostridiales are cultured together in the relative abundance as found in the distal gut community of a person with normal microbiota (i.e., the conditions of the community in which the probiotic formulation will be applied).

Probiotic cultures described herein may include one or more of the bacteria described in Table 1 in an amount designed to restore a healthy flora to the patient being treated. Thus, the probiotic culture restores healthy levels of native bacterial species such that the native bacterial species can to inhibit the growth of harmful species.

In one embodiment, a probiotic culture is intended to quickly restore a microbial community at the site of treatment, prior to elimination from the body.

One limitation of current probiotic formulations is that they move quickly through the intestines and may not have sufficient time to adjust to the intestinal milieu prior to passage through the body. In contrast, the probiotic formulations of the present invention are formulated such that they can survive passage through the acidic environment of the stomach and such that they adjust quickly to the intestinal environment. Such formulation allows the presently described probiotic compositions to have a longer half-life in the intestines.

The inventors have identified for the first time herein that therapeutic bacterial can be conditioned such that the microbes are optimized for administration to a particular environment (e.g., the gut, a mucosal surface, etc.). That is, in the manufacturing process of a probiotic culture, a combination, of microbes is cultured such that they flourish in a diseased environment and are able to quickly alter the unhealthy microbial population contributing to a diseased stated. By virtue of this conditioning, the bacteria are cultured in a way so that they more closely mimic the competitive environment they would see in, for example, the gut, so the bacteria can immediately start transcribing therapeutic genes to restore a healthy flora.

In one aspect, probiotic cultures described herein not only contain therapeutic microbes that for treatment of the medical conditions, but which also may contain microbes expected to be in the environment to be treated.

In one embodiment, the target site is the distal gut and microbes are grown in conditions similar to healthy and diseased gut (as in the case of colon cancer). Probiotic compositions are prepared from cultures which are conditioned to flourish in an unhealthy environment and which provide a therapeutic benefit following administration to a patient diagnosed with colon cancer.

In another embodiment, the target site is the nasal environment and microbes are grown in conditions similar to healthy and unhealthy mucosal states (as in the case of allergies). Probiotic compositions are prepared from cultures which are conditioned to flourish in an unhealthy environment and which provide a therapeutic benefit following administration to a patient diagnosed with Allergic Rhinitis.

In another embodiment, the target site is the skin and microbes are grown in conditions similar to healthy and diseased skin (as in the case of a methicillin-resistant S. aureus infection). Probiotic compositions are prepared from cultures which are conditioned to flourish in an unhealthy environment and which provide a therapeutic benefit following administration to a patient diagnosed with MRSA.

The present inventors have identified that culturing the bacteria in an other than typically optimal set of conditions may better prepare the bacteria for survival in the unhealthy flora that is contributing to a medical condition. Such in vitro conditioning prior to in vivo administration generates a more robust bacterial culture that is better able to survive the milieu of a target site that is contributing to a medical condition.

One would understand that any number of activators and/or repressors may be added to the cultures in order to enhance or decrease one or more species of bacteria in order to restore a healthy flora. Activators and repressors are conventionally known in the art.

One or more of the microbes in the bacterial co-cultures described herein may also be genetically modified. For example, a microbial population may be recombinantly engineered to overexpress one or more proteins which are lacking in a patient identified with a medical condition. Alternatively, a microbial population may be recombinantly engineered to express one or more proteins that inhibit a protein that is causing a medical condition.

In one embodiment, provided herein is a probiotic culture of microbes that inhibit overgrowth of Clostridium difficile in order to treat an adverse bacterial infection.

In one embodiment, provided herein is a probiotic culture comprising Bacteroides and Bifidobacteria that inhibits growth of C. difficile and S. aureus for the treatment of allergies.

In one embodiment, provided herein is a probiotic culture comprising microbes that inhibits growth of C. difficile and Salmonella kedougou for the treatment of antibiotic-associated diarrhea.

In one embodiment, provided herein is a probiotic culture comprising microbes of genera such as, for example, Lactobacillus and Bifidobacteria, that inhibit genera of bacteria such as Bacteroides and Clostridium for treatment of tumors.

In one embodiment, provided herein is a culture for conditioning as described above for treatment of colon cancer which may comprise one or more of the following bacteria: S. epidermidis, S. aureus, S. mitis, Lactobacillus sp., Clostridium sp., C. tetani, Corynebacteria, Mycobacteria, Spirochetes and Mycoplasma.

In one embodiment, provided herein is a culture for conditioning as described above for treatment of Allergic Rhinitis which may comprise one or more of the following bacteria: S. epidermidis, S. aureus, Corynebacteria and Mycobacteria.

In one embodiment, provided herein is a culture for conditioning as described above for treatment of MRSA which may comprise one or more of the following bacteria: S. epidermidis, Corynebacteria and Mycobacteria.

Bacterial co-cultures described herein for therapy may be administered in a pharmaceutical formulation, i.e., formulated with a suitable pharmaceutical excipient, diluent or carrier selected for the intended route of administration and standard pharmaceutical practice. The excipient, diluent and/or carrier are compatible with the other ingredients of the formulation and not deleterious to the recipient thereof. Acceptable excipients, diluents, and carriers for therapeutic use are well known in the pharmaceutical art, and are described, for example, in Remington: The Science and Practice of Pharmacy. Lippincott Williams & Wilkins (A. R. Gennaro edit. 2005). The choice of pharmaceutical excipient, diluent, and carrier may be selected with regard to the intended route of administration and standard pharmaceutical practice. Compositions of the present invention may be prepared for delivery as a solution, a tablet, or as a lyophilized culture. Where cultures are lyophilized, the preparation can be rehydrated in, for example, yogurt or water for administration.

Although there are no physical limitations to delivery of the formulations, oral delivery may be used delivery to the digestive tract because of its ease and convenience, and because oral formulations readily accommodate additional mixtures, such as milk, yogurt, and infant formula. For delivery to the colon, bacteria may be also administered rectally or by enema. Topical delivery is used when the formulations are delivered to cutaneous microbiota. For delivery to nasal microbiota, delivery route is typically via an intranasal route. For injection to an internal environment, bacterial co-cultures may be administered via injection to a site of treatment.

Bacterial strains administered according to the present methods can comprise live bacteria. One or several different bacterial strains can be administered simultaneously or sequentially (including administering at different times). Such bacteria can be isolated from microbiota and grown in culture using known techniques. However, certain bacterial species are difficult to culture and administration of others (like H. pylori) may lead to various undesirable side-effects. Therefore, it would be understood that the present methods contemplate administering to a patient “bacterial analogues”, such as recombinant carrier strains expressing one or more heterologous genes derived from the bacteria affected in a disease. The use of such recombinant bacteria may allow the use of lower therapeutic amounts due to higher protein expression and may simultaneously allow the patient to avoid any potential harmful side-effects associated with reintroduction of specific bacterial strains. Methods describing the use of bacteria for heterologous protein delivery are described, e.g., in U.S. Pat. No. 6,803,231.

In certain embodiments, a conditional lethal bacterial strain can be utilized in the composition or to deliver a recombinant construct. Such a conditional lethal bacteria survives for a limited time typically when provided certain nutritional supplements. Such a supplement may be a liquid, formulated to contain the nutritional component necessary to keep the bacteria alive. A patient/subject may drink such a supplement in intervals to keep the bacteria alive until the condition is partially or fully resolved. Once the supplement is depleted, the conditional lethal bacteria die. Methods relating to conditional lethal strains of, for example, H. pylori are described in U.S. Pat. No. 6,570,004.

Cultures of bacteria may be maintained under conditions identified to induce or train the metatranscriptome to alter the microbiome of a patient to be treated following administration. For example, a microbial population may be optimized by genetic engineering, culturing in the presence of one or more activators, one or more inhibitors (repressors), or a combination thereof. Media may be altered to contain one or more nutrients that optimize growth of one or more species of a particular culture.

In one aspect, formulations of metabolites, often identified and taken from the culture conditioning media, may be used as formulations to modify and optimize the metatranscriptome to restore health.

A bacterial composition for use in the present methods may comprise a buffering agent. Exemplary examples of useful buffering agents include sodium bicarbonate, milk, yoghurt, infant formula, and other dairy products.

Bacterial cultures can be mixed and matched in various combinations to optimize treatment of a medical condition as described above. Thus, formulations may undergo phylogenetic and/or metagenomic conditioning by co-culture of populations of selected species to optimize a co-culture of bacteria for use in treating a metabolic condition described herein. In one embodiment, one or more of the bacteria in the cultures may be a recombinant organism modified to optimize the transcriptome for therapeutic treatment. One or more exogenous agents (e.g., activators and/or repressors), may be added to the culture to optimize the transcriptome for therapeutic treatment. Similarly, the bacteria may produce one or more metabolites and/or one or more may be exogenously added to the culture to optimize the transcriptome for therapeutic treatment. In each of such examples, media conditioning and/or or metatranscriptome conditioning of formulations may be conducted to optimize the metatranscriptome in a given formulation by culturing the bacteria under conditions to induce or train the metatranscriptome in a manner designed to restore the normal flora.

In one non-limiting example, provided herein is a method for culturing bacteria which are capable of lowering cholesterol when administered to a patient. Bacteria are grown on cholesterol as sole carbon source, and a bacterial culture is selected which has a metatranscriptome conducive for treating hypercholesteremia.

Administration of a bacterial composition may be accomplished by any method likely to introduce the organisms into the desired location. The bacteria may be mixed with a carrier and (for easier delivery to the digestive tract) applied to liquid or solid food, or feed or to drinking water. The carrier material should be non-toxic to the bacteria and the subject/patient. In one embodiment, the carrier contains an ingredient that promotes viability of the bacteria during storage. The formulation may include added ingredients to improve palatability, improve shelf-life, impart nutritional benefits, and the like. If a reproducible and measured dose is desired, the bacteria may be administered by a rumen cannula.

The dosage of the bacterial composition may vary depending upon the nature of the disease, the patient's medical history, the frequency of administration, the manner of administration, the clearance of the agent from the patient, and the like. The initial dose may be larger, followed by smaller maintenance doses. The dose may be administered as infrequently as weekly or biweekly, or fractionated into smaller doses and administered daily, semi-weekly, etc., to maintain an effective dosage level. It is contemplated that a variety of doses will be effective to achieve colonization of the gastrointestinal tract with the desired bacterial composition, e.g., 10⁶, 10⁷, 10⁸, 10⁹, and 10¹⁰ CFU for example, can be administered in a single dose. Lower doses can also be effective, e.g., 10⁴, and 10⁵ CFU. Similar doses can be used for administration to skin and nasal mucosa.

In conjunction with the diagnostic methods, provided herein are therapeutic methods for medical conditions such as, for example, cancers, infections, autoimmune diseases, inflammatory conditions and metabolic conditions by restoring the normal mammalian bacterial gastrointestinal microbiota to that observed in healthy subjects.

In a more general aspect, provided herein is a method for treating various diseases associated with changes in gastrointestinal, cutaneous (skin), or nasal microbiota by restoring such microbiota to that observed in healthy subjects.

In certain specific embodiments, restoring of microbiota is achieved by administering to a mammal in need thereof a therapeutically effective amount of a probiotic composition comprising an effective amount of at least one bacterial strain, or a combination of several strains, wherein the composition (i) stimulates or inhibits transcription of specific genes involved in metabolic pathways that are involved in host energy homeostasis and/or (ii) stimulates growth and/or activity of bacteria which are under-represented in a medical condition and/or (iii) inhibits growth and/or activity of bacteria which are over-represented in a medical condition.

Provided herein is a method for treating a medical condition by restoring mammalian bacterial gastrointestinal microbiota comprising administering to a mammal in need of such treatment, an effective amount of at least one gastric, esophageal, or colonic bacteria, or a combination thereof. The bacteria may be administered orally, rectally or by enema.

Non-limiting examples of the diseases treatable by the methods described herein include autoimmune diseases such as, for example, rheumatism, rheumatoid arthritis, multiple sclerosis, neuro-autoimmune diseases (Guillain-Barre syndrome, neuro-Behcet's disease, etc.), type I (insulin-dependent) diabetes, systemic lupus erythematosus (SLE), Ankylosing Spondylitis, Bickerstaffs encephalitis, autoimmune pancreatitis, eczema, Celiac disease, Grave's disease, Myasthenia gravis, Scleroderma, and Sjogren's syndrome, which are known as intractable diseases (Clinical Immunology and Immunopathology, 84, 223-243 (1997)). Other autoimmune diseases are known in the art and are contemplated herein.

Non-limiting examples of the diseases treatable by the methods described herein include cancers (e.g., any solid or blood-borne cancer) such as, for example, lymphomas, leukemias, carcinomas, sarcomas, blastomas, or germ cell tumors. In one embodiment, the cancer to be treated is colon cancer, colorectal cancer, skin cancer, lung cancer, breast cancer, prostate cancer, pancreatic cancer, testicular cancer, bladder cancer, cervical cancer, ovarian cancer, stomach cancer, esophageal cancer, oral cancer, and gastric cancer. Other cancers are known in the art and are contemplated herein.

Non-limiting examples of the conditions treatable by the methods described herein include metabolic conditions such as, for example, a disorder of carbohydrate metabolism (e.g., glycogen storage disease), amino acid metabolism (e.g., phenylketonuria , maple syrup urine disease, glutaric acidemia type 1), organic acid metabolism (e.g., alcaptonuria), fatty acid oxidation and mitochondrial metabolism (e.g., Medium-chain acyl-coenzyme A dehydrogenase deficiency (MCADD)), porphyrin metabolism (e.g., acute intermittent porphyria), purine or pyrimidine metabolism (e.g., Lesch-Nyhan syndrome), steroid metabolism (e.g., congenital adrenal hyperplasia), mitochondrial function (e.g., Kearns-Sayre syndrome), peroxisomal function (e.g., Zellweger syndrome) or lysosomal storage (e.g., Gaucher's disease or Niemann Pick disease), obesity, metabolic syndrome, insulin-deficiency or insulin-resistance related disorders, ischemia, oxidative stress, atherosclerosis, hypertension, abnormal lipid metabolism, gastrointestinal reflux disease (GERD), and eosinophilic esophagitis.

Non-limiting examples of the conditions treatable by the methods described herein include infections that are due an overabundance of bacteria or viruses that cause a patient to be sick. In one embodiment, the infection to be treated is caused by bacteria such as methicillin-resistant Staphylococcus aureus (MRSA), Clostridium difficile, Pseudomonas aeruginosa and vancomycin-resistant enterococci. In another embodiment, the invention to be treated is caused by a virus such as human immunodeficiency virus. Treatment of infections caused by other bacteria and viruses are also contemplated herein.

Additional non-limiting examples of the conditions treatable by the methods described herein include inflammatory diseases such as, for example, irritable bowel syndrome, ulcerative colitis, Crohn's disease, asthma and allergy.

Provided herein is a method of treating colon cancer by administering a therapeutic oral probiotic preparation, thereby decreasing urease activity of the flora of the diseased patient and restoring the normal flora. The amount of probiotic preparation to be administered may be empirically determined by the treating physician to determine the optimal concentration and ratio based in the stage of disease and patient statistics (e.g., age, height, weight, etc.). Treatment may further include altering the patient's diet by (1) decreasing dietary fat and flesh and (2) increasing fiber consumption. In one embodiment, treatment may also include administration of a probiotic culture of one or more of S. epidermidis, S. aureus, S. mitis, Lactobacillus sp., Clostridium sp., C. tetani, Corynebacteria, Mycobacteria, Spirochetes, Mycoplasma, Bacteroides, Proteus Klebsiella species, or a combination thereof. In another embodiment, treatment of colon cancer may also include one or more conventional regimens including, for example, surgery, chemotherapy, radiation therapy, immunotherapy, antisense therapy or a combination thereof.

Provided herein is a method of treating cirrhosis by administering a therapeutic oral probiotic preparation, thereby decreasing decarboxylase activity of the flora of the diseased patient and restoring the normal flora. The amount of probiotic preparation to be administered may be empirically determined by the treating physician to determine the optimal concentration and ratio based in the stage of disease and patient statistics (e.g., age, height, weight, etc.). Treatment may further include altering the patient's diet by (1) decreasing dietary fat and flesh and (2) increasing fiber consumption. In another embodiment, treatment of cirrhosis may also include one or more conventional regimens including, for example, interferons, corticosteroids, chelation therapy, vaccination for Hepatitis A, vaccination for Hepatitis B, diuretics, propranolol, transjugular intrahepatic portosystemic shunting, liver transplantation or a combination thereof.

Provided herein is a method of treating cancer by administering a therapeutic oral probiotic preparation, thereby decreasing tryptophanase activity of the flora of the diseased patient and restoring the normal flora. The amount of probiotic preparation to be administered may be empirically determined by the treating physician to determine the optimal concentration and ratio based in the stage of disease and patient statistics (e.g., age, height, weight, etc.). Treatment may further include altering the patient's diet by (1) decreasing dietary fat and flesh and (2) increasing fiber consumption. In another embodiment, treatment of cancer may also include one or more conventional regimens including, for example, surgery, chemotherapy, radiation therapy, anti-angiogenesis, immunotherapy, antisense therapy or a combination thereof.

Provided herein is a method of treating cancer by administering a therapeutic oral probiotic preparation, thereby decreasing beta-glucuronidase activity of the flora of the diseased patient and restoring the normal flora. The amount of probiotic preparation to be administered may be empirically determined by the treating physician to determine the optimal concentration and ratio based in the stage of disease and patient statistics (e.g., age, height, weight, etc.). Treatment may further include altering the patient's diet by (1) decreasing dietary fat and flesh and (2) increasing fiber consumption. In another embodiment, treatment of cancer may also include one or more conventional regimens including, for example, surgery, chemotherapy, radiation therapy, anti-angiogenesis, immunotherapy, antisense therapy or a combination thereof.

In addition to the combination therapies described above for each indication, one or more further treatment regimens may also be administered to a patient. For example, putrefaction dysbiosis may also be managed with a diet high in both soluble and insoluble fiber and low in saturated fat and animal protein along with fermented dairy foods like fresh yogurt. These dietary changes may lower the concentrations of harmful microbes and increase concentrations of healthy microbes. Supplementing a patient's diet with defined sources of fiber may have an effect on colonic dysbiosis: insoluble fiber may decrease bacterial concentration and microbial enzyme activity whereas soluble fiber may elevate bacterial concentration and enzyme activity at the same time that it raises the levels of beneficial short chain fatty acids. Fructose-containing oligosaccharides, found in vegetables like onion and asparagus, may also be utilized as a food supplement for raising stool levels of healthy bacteria and lowering the stool pH.

Provided herein is a method of treating fermentation or carbohydrate intolerance by administering an oral probiotic culture, thereby decreasing bacterial protease activity of the flora of the diseased patient and restoring the normal flora in the stomach, small intestine and cecum. The ratio of bacteria in the probiotic preparations may be empirically determined by the treating physician to determine the optimal concentration and ratio based in the stage of disease and patient statistics (e.g., age, height, weight, etc.). Treatment may further include altering the patient's diet to reduce carbohydrate consumption.

Provided herein is a method of treating Travelers' Diarrhea comprising administering to a patient a probiotic composition that restores the normal gut flora by decreasing the relative abundance of microbes of the phyla Actinobacteria and Firmicutes and which increases the relative abundance of the phylum Bacteroidetes.

Provided herein is a method of treating venous insufficiency wounds comprising administering to a patient a probiotic composition that restores the normal flora by decreasing the levels of Bacteroidetes and Actinobacteria at the site of the wound.

Provided herein is a method of altering the gut flora of a patient by administering a probiotic composition comprising defined strains of E. coli and Enterococcus to the patient.

Provided herein is a method of reducing fecal concentrations of Clostridia and Enterobacter species, ammonia, and toxigenic bacterial enzymes including beta-glucuronidase and tryptophanase comprising administering a by administering a probiotic composition comprising Bifidobacterium brevum to the patient.

Provided herein is a method of treating small bowel dysbiosis in a patient by administering a probiotic composition comprising Bacillus laterosporus to the patient, wherein said composition produces metabolites with antibiotic, anti-tumor and immune modulating activity.

Provided herein is a method of preventing antibiotic-associated diarrhea and Clostridium difficile colitis by administering a probiotic composition comprising Saccharomyces boulardii to the patient.

Provided herein is a method of treating ankylosing spondylitis by administering a probiotic composition comprising bacteria that inhibit Klebsiella pneumonia.

Combination Treatments

For an enhanced therapeutic effect, the bacterial compositions described herein can be administered in combination with other therapeutic agents or regimes. The choice of therapeutic agents that can be co-administered with the bacterial compositions depends, in part, on the condition being treated.

Non-limiting examples of additional pharmaceutically active compounds useful for treatment of obesity, metabolic syndrome, and related disorders such as insulin-deficiency or insulin-resistance related disorders, ischemia, oxidative stress, atherosclerosis, hypertension, abnormal lipid metabolism include anti-inflammatory agents, antioxidants, anti-arrhythmics, cytokines, analgesics, vasodilators, antihypertensive agents including beta-blockers, angiotensin converting enzyme inhibitors (ACE inhibitors), and calcium channel blockers, inhibitors of cholesterol synthesis, antithrombotic agents, and diabetes drugs.

Non-limiting examples of inhibitors of cholesterol synthesis or absorption useful in the combination therapies include, but are not limited to, Hmg-CoA reductase inhibitors and their bio-active metabolites, such as, e.g., simvastatin, lovastatin, pravastatin, compactin, fluvastatin, dalvastatin, atorvastatin, HR-780, GR-95030, CI-981, BMY 22089, and BMY 22566. See, e.g., U.S. Pat. Nos. 4,346,227; 4,444,784; 4,857,522; 5,190,970; 5,316,765, and 5,461,039; PCT Publ. No. W084/02131; GB Pat. No. 2,202,846. Any one or several of the Hmg-CoA reductase inhibitor compounds may be mixed with L-arginine or a substrate precursor to endogenous nitric oxide, as described in U.S. Pat. Nos. 6,425,881 and 6,239,172, and 5,968,983, to provide a therapeutically effective mixture.

Non-limiting examples of diabetes drugs useful in combination therapies include insulin, proinsulin, insulin analogs, activin, glucagon, somatostatin, amylin, actos (pioglitazone), amaryl (glimepiride), glipizide, avandia (rosiglitazone), glucophage, glucotrol, glucovance (a combination of glyburide and metformin), and the like. See, e.g., U.S. Pat. No. 6,610,272. The term “insulin” encompasses natural extracted human insulin, recombinantly produced human insulin, insulin extracted from bovine and/or porcine sources, recombinantly produced porcine and bovine insulin and mixtures of any of these insulin products. Administering a bacterial composition described herein in combination with insulin may lower the dose of insulin required to manage the diabetic patient, while also alleviating the symptoms of metabolic syndrome.

Non-limiting examples of anti-cancer agents useful in combination therapies include, but are not limited to, chemotherapy (splatin, doxorubicin, etoposide, camptothecin, etc.), immunotherapy (e.g., co-stimulatory molecules such as B7, CD137-L, CD134-L, GITR-L and CD40, etc.); radiation therapy (external beam or brachytherapy); hormone therapy (e.g., orchiectomy, LHRH-analog therapy to suppress testosterone production, anti-androgen therapy); monoclonal antibody therapy (e.g., HUMIRA®, RITUXIMAB®, an anti-nuclear antigen specific antibody that is a murine, chimeric, humanized, or human form of murine antibody TNT-1, TNT-2, or TNT-3, or is NHS76). Examples of cytotoxic agents include, but are not limited to ricin, doxorubicin, daunorubicin, taxol, ethiduim bromide, mitomycin, etoposide, tenoposide, vincristine, vinblastine, colchicine, dihydroxy anthracin dione, actinomycin D, diphteria toxin, Pseudomonas exotoxin (PE) A, PE40, abrin, and glucocorticoid and other chemotherapeutic agents, as well as radioisotopes.

Non-limitingexamples of autoimmune disease therapeutic agents useful in combination therapies include, but are not limited to, ENBREL®, laquinimod, methotrexate, spirocyclic heterocyclic derivatives, imidazolopyrazine compounds, antibody therapeutics, triazolopyrazine compounds, etc.

Non-limitingexamples of agents that may be administered to treat infections in combination therapies include, for example, one or more antibiotics.

Digital Processing Device

In some embodiments, the methods, systems, and software described herein include a digital processing device, or use of the same. In further embodiments, the digital processing device includes one or more hardware central processing units (CPU) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by Way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera to capture motion or visual input. In still further embodiments, the input device is a combination of devices such as those disclosed herein.

Non-Transitory Computer Readable Storage Medium

In some embodiments, the methods, systems, and software disclosed herein include one or more computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

Computer Program

In some embodiments, the methods, systems, and software disclosed herein include at least one computer program, or use of the same. A computer program includes a sequence of instructions, executable in the digital processing device's CPU, written to perform a specified task. In light of the disclosure provided herein, those of skill in the art will recognize that a computer program may be written in various versions of various languages. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. A web application for providing a career development network for artists that allows artists to upload information and media files, in some embodiments, includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

Stand Alone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

Software Modules

The methods, systems, and software disclosed herein include, in various embodiments, software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. hi other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

Databases

In some embodiments, the methods, systems, and software disclosed herein include one or more databases, or use of the same. In view of the disclosure provided herein, those of skill in the art will recognize that many databases are suitable for storage and retrieval of metagenomic information (including metagenomic profiles), metatranscriptome information (including metatranscriptome profiles), and multiplex profiles. In various embodiments, suitable databases include, by way of non-limiting examples, relational databases, non-relational databases, object oriented databases, object databases, entity-relationship model databases, associative databases, and XML databases. In some embodiments, a database is Internet-based. In further embodiments, a database is web-based. In still further embodiments, a database is cloud computing-based. In other embodiments, a database is based on one or more local storage devices.

Computer Based Applications

Provided herein is a computer-implemented system for diagnosing the presence or absence of a medical condition in a mammal, comprising: (a) a digital processing device comprising an operating system configured to perform executable instructions and a memory device; and (b) a computer program including instructions executable by the digital processing device, the computer program comprising: (i) a module configured to determine a metagenomic profile by receiving and quantifying metagenomic information for at least a portion of 16S ribosomal RNA of a sample from said mammal; (ii) a module configured to determine a metatranscriptome profile by receiving and quantifying metatranscriptome information for at least a portion of messenger RNA of said sample; (iii) a module configured to compare a multiplex profile of a metatranscriptome profile and a metagenomic profile to a multiplex profile of a population of mammals diagnosed with said medical condition to determine the presence or absence of the medical condition; and (iv) a module configured to generate a report of the result of the comparison, the report comprising a diagnosis. In one embodiment, the computer program further comprises a module configured to combine the metagenomic and metatranscriptome profiles into the multiplex profile. The medical condition may be a cancer, an infection, an inflammatory disease, an autoimmune disease, a hormonal disease, a psychological disease or a metabolic disease. Quantifying the 16S ribosomal RNA may be accomplished using any method known in the art including, but not limited to, quantitative polymerase chain reaction (PCR), microarray analysis, and next generation cDNA sequencing. Quantifying the messenger RNA may be accomplished using any method known in the art including, but not limited to, a microarray/high-density array assay or an mRNA-derived cDNA clone library assay. The computer-implemented system may further comprise a database of multiplex profiles of mammals diagnosed with said medical condition.

Provided herein is a computer -implemented system for diagnosing the presence or absence of a medical condition in a mammal comprising: (a) a digital processing device comprising an operating system configured to perform executable instructions and a memory device; and (b) a computer program including instructions executable by the digital processing device, the computer program comprising: (i) a module configured to determine a metatranscriptome profile by receiving and quantifying metatranscriptome information for at least a portion of messenger RNA of a sample from said mammal; (ii) a module configured to compare the metatranscriptome profile to the metatranscriptome of a population of mammals diagnosed with said medical condition to determine the presence or absence of the medical condition; and (iii) a module configured to generate a report of the result of the comparison, the report comprising a diagnosis.

Provided herein is a non-transitory computer-readable storage media encoded with a computer program including instructions executable by a processor to create a diagnostic application comprising: (a) a module configured to determine a metagenomic profile by receiving and quantifying metagenomic information for at least a portion of 16S ribosomal RNA of a sample from a mammal; (b) a module configured to determine a metatranscriptome profile by receiving and quantifying metatranscriptome information for at least a portion of messenger RNA of said sample; (c) a module configured to compare a multiplex profile of a metatranscriptome profile and a metagenomic profile to a multiplex profile of a population of mammals diagnosed with a medical condition to determine the presence or absence of the medical condition; and (d) a module configured to generate a report of the result of the comparison, the report comprising a diagnosis. The application may further comprise a module configured to combine the metagenomic and metatranscriptome profiles into the multiplex profile. The medical condition may be a cancer, an infection, an inflammatory disease, an autoimmune disease, a hormonal disease, a psychological disease or a metabolic disease. Quantifying the 16S ribosomal RNA may be accomplished using any method known in the art including, but not limited to, quantitative polymerase chain reaction (PCR), microarray analysis, and next generation cDNA sequencing. Quantifying the messenger RNA may be accomplished using any method known in the art including, but not limited to, a microarray/high-density array assay or an mRNA-derived cDNA clone library assay. In one embodiment, the media further comprises a database of multiplex profiles of mammals diagnosed with said medical condition.

Provided herein is a non-transitory computer-readable storage media encoded with a computer program including instructions executable by a processor to create a diagnostic application comprising: (a) a module configured to determine a metatranscriptome profile by receiving and quantifying metatranscriptome information for at least a portion of messenger RNA of a sample from a mammal; (b) a module configured to compare the metatranscriptome profile to the metatranscriptome of a population of mammals diagnosed with a medical condition to determine the presence or absence of the medical condition; and (c) a module configured to generate a report of the result of the comparison, the report comprising a diagnosis.

### EXAMPLES

### Example 1

### Diagnosis of Colon Cancer

Mouse models for colon cancer are known in the art and are described by, for example, Taketo M M (2006). “Mouse models of gastrointestinal tumors”. Cancer Sci. 97 (5): 355-61; Neufert C, Becker C, Neurath M F (2007). “An inducible mouse model of colon carcinogenesis for the analysis of sporadic and inflammation-driven tumor progression”. Nat Protoc 2 (8): 1998-2004; and Tanaka T, Kohno H, Suzuki R, Yamada Y, Sugie S, Mori H (2003). “A novel inflammation-related mouse colon carcinogenesis model induced by azoxymethane and dextran sodium sulfate”. Cancer Sci. 94 (11): 965-73. Animals are housed and treated according to standard protocols and treatment conditions. Control mice are not treated to induce colon cancer. Four mice per group are treated.

Following development of tumors in the animals, fecal samples may be obtained at one or more time points. Total RNA and mRNA are extracted and isolated as described above using commercially available kits according to the manufacturer's instructions.

16S rRNA is analyzed and the microbial taxonomic data is determined for test and control sample groups as described above.

mRNA is analyzed using the methods described above and the transcript profile of mice having colon cancer is compared to control mice can be conducted.

A profile for diagnosing colon cancer is developed in which the relative abundance of the phylogenetic data is ranked on the X-axis as −log data with the mean thus being zero; the relative abundance bacterial urease mRNA is ranked along the Y-axis as −log data with the mean thus being zero; and the colon cancer is characterized by an increase in species/urease mRNA and a decrease in species/urease mRNA. Mice having an increase in urease mRNA and log abundance of bacteria compared to control animals are diagnosed as having colon cancer.

A formulation of probiotic bacteria is designed to increase the species and to increase the transcripts found in the upper, right field and/or to decrease the species and to decrease the transcripts in the lower right field.

While preferred embodiments have been shown and described herein, it will be obvious to those skilled in the art that such embodiments are provided by way of example only. Numerous variations, changes, and substitutions will now occur to those skilled in the art without departing from disclosed embodiments. It should be understood that various alternatives to the embodiments described herein may be employed. It is intended that the following claims define the scope of the embodiments and that methods and structures within the scope of these claims and their equivalents be covered thereby.

### REFERENCES

1. US20100074872A1

2. U.S. Pat. No. 6,348,452

3. U.S. Pat. No. 7,887,794

4. US20100254956A1

5. US20100129816A1

6. US20100172874A1

7. US20110212850A1

8. US20050239706A1

9. US20090098240A1

10. US20090110664A1

11. US20100093064A1

12. US20100254949A1

13. US20110040081A1

14. US20110107439A1

15. US20110189763A1

16. US20110196027A1

17. Simon and Daniel. (2011) Appl. Environ. Microbiol., 77(4): 1153-1161

1. A method of diagnosing the presence or absence of a medical condition in a mammal comprising:
a. isolating and quantifying at least a portion of 16S ribosomal RNA of a sample from said patient to determine a metagenomic profile;
b. isolating and quantifying at least a portion of messenger RNA of said sample to determine a metatranscriptome profile; and
c. comparing, using a general purpose computer, a multiplex profile of a metatranscriptome profile and a metagenomic profile to a multiplex profile of a population of patients diagnosed with said medical condition to determine the presence or absence of the medical condition.

2. The method claim 1, further comprising combining the metagenomic and metatranscriptome profiles into the multiplex profile using a general purpose computer.

3. The method of claim 1, wherein said medical condition is a cancer, an infection, an inflammatory disease, an autoimmune disease, a hormonal disease, a psychological disease or a metabolic disease.

4. The method of claim 3, wherein said infection is a bacterial or viral infection.

5. The method of claim 1, wherein quantifying the 16S ribosomal RNA comprises quantitative polymerase chain reaction (PCR), microarray analysis, or next generation cDNA sequencing.

6. The method of claim 1, wherein quantifying the messenger RNA comprises a microarray/high-density array assay or an mRNA-derived cDNA clone library assay.

7. (canceled)

8. A method of treating patient diagnosed with a medical condition of claim 1, comprising
a. identifying an imbalance of microbes in a sample from said patient; and
b. restoring or correcting disease- or medical condition-related imbalances in the microbiome of the patient based on the microbiome profile with culture-conditioned formulations in which the transcriptome activity of the administered organisms is optimized.

9. (canceled)

10. A bacterial culture comprising a therapeutic bacteria grown in the presence of one or more other bacteria found at a desired treatment site as identified in Table 1.

11. The bacterial culture of claim 10, further comprising one or more activators, one or more repressors, or a combination thereof.

12. The bacterial culture of claim 10, which produces one or more therapeutic metabolites.

13. The bacterial culture of claim 10, wherein one or more of the bacteria are genetically engineered bacteria.

14. A method of treating patient diagnosed with a medical condition, comprising
a. identifying an imbalance of microbes in a sample from said patient; and
b. administering a probiotic composition comprising a bacterial culture of claim 10, wherein said composition restores or corrects disease- or medical condition-related imbalances in the microbiome of the patient.

15. (canceled)

16. A computer-implemented system for diagnosing the presence or absence of a medical condition in a mammal, comprising:
a. a digital processing device comprising an operating system configured to perform executable instructions and a memory device; and
b. a computer program including instructions executable by the digital processing device, the computer program comprising:
(i) a module configured to determine a metagenomic profile by receiving and quantifying metagenomic information for at least a portion of 16S ribosomal RNA of a sample from said mammal;
(ii) a module configured to determine a metatranscriptome profile by receiving and quantifying metatranscriptome information for at least a portion of messenger RNA of said sample;
(iii) a module configured to compare a multiplex profile of a metatranscriptome profile and a metagenomic profile to a multiplex profile of a population of mammals diagnosed with said medical condition to determine the presence or absence of the medical condition; and
(iv) a module configured to generate a report of the result of the comparison, the report comprising a diagnosis.

17. The computer-implemented system claim 16, wherein the computer program further comprises a module configured to combine the metagenomic and metatranscriptome profiles into the multiplex profile.

18. The computer-implemented system claim 16, wherein said medical condition is a cancer, an infection, an inflammatory disease, an autoimmune disease, a hormonal disease, a psychological disease or a metabolic disease.

19. The computer-implemented system claim 18, wherein said infection is a bacterial or viral infection.

20. The computer-implemented system claim 16, wherein quantifying the 16S ribosomal RNA comprises quantitative polymerase chain reaction (PCR), microarray analysis, or next generation cDNA sequencing.

21. The computer-implemented system claim 16, wherein quantifying the messenger RNA comprises a microarray/high-density array assay or an mRNA-derived cDNA clone library assay.

22. The computer-implemented system claim 16, further comprising a database of multiplex profiles of mammals diagnosed with said medical condition.

23.-31. (canceled)
